(19) United States
(12) Patent Application Publication
(10) Pub. No.: US 2016/0048652 A1
(43) Pub. Date: Feb. 18, 2016

(54) PLATFORM FOR PROVIDING MEDICAL CARE RECOMMENDATIONS

(71) Applicants: John Spivey, Brentwood, TN (US); Tarun Jolly, New Orleans, LA (US); Warren Husband, Jackson, MS (US); Sanjeev Rajan, Redmond, WA (US); Todd McCoy, Baton Rouge, LA (US)

(72) Inventors: John Spivey, Brentwood, TN (US); Tarun Jolly, New Orleans, LA (US); Warren Husband, Jackson, MS (US); Sanjeev Rajan, Redmond, WA (US); Todd McCoy, Baton Rouge, LA (US)

(21) Appl. No.: 14/462,097

(22) Filed: Aug. 18, 2014

(51) Int. Cl. G06F 19/00

(52) U.S. Cl. CPC G06F 19/3418; G06F 19/326; G06F 19/3487

(57) ABSTRACT

The disclosed technology includes systems, methods, apparatuses, and computer-readable mediums for facilitating electronic analysis of medication related data and providing detailed analysis in a comprehensible format for access by ordinary, non-expert individuals (“the disclosed technology”). Briefly described, the disclosed technology includes processing and aggregating, from different data sources, laboratory data (e.g., DNA test results), medication data (e.g., list of medications), and/or medical history data, analyzing the different data to create medication pathway mappings associated with a patient's medical profile, and delivering, to the patient, real-time detailed analysis of adverse drug interactions and/or adverse prescribed treatments based on the medication pathway mappings.

### TECHNICAL FIELD

The present invention generally relates to a system and method for managing patient healthcare information, and specifically to providing real-time medication-interaction analysis through a mobile application.

### BACKGROUND

With the pervasiveness of computing devices and computer networks (e.g., the Internet), the electronic availability of healthcare related information has become increasingly abundant. Healthcare related information includes, for example, medical records, examination results, genetic profiles, drug interaction research, etc. Such information can come from many different sources, including, for example, physicians, hospitals, pharmacies, researchers, and testing laboratories. However, these sources often maintain different electronic database systems to manage their respective data, rendering it difficult to access information quickly and efficiently, and preventing important diagnoses, preventions, and treatments for patients. Further, the more complex, yet important data, such as complex DNA findings, are often offered in a raw, unanalyzed form that only the most trained specialists are able to understand, making it highly incomprehensible to patients, and even physicians, attempting to administer healthcare to the patients.

### BRIEF DESCRIPTION OF DRAWINGS

The present embodiments are illustrated by way of example and are not intended to be limited by the figures of the accompanying drawings. In the drawings:

FIG. 1 illustrates a computer network environment within which some embodiments can be implemented;

FIG. 2 illustrates a block diagram further explaining certain components and functionalities thereof in a server, which can be the server 130 of FIG. 1 in accordance with some embodiments;

FIGS. 3A-3C respectively illustrate a user interface which can be generated by the server of FIG. 1 for facilitating a login to the medication analysis platform system in accordance with some embodiments;

FIG. 4 illustrates a user interface which can be generated by the server of FIG. 1 for accessing various features of the medication analysis platform system in accordance with some embodiments;

FIGS. 5A-5C respectively illustrate a user interface which can be generated by the server of FIG. 1 for managing medications within the medication analysis platform system in accordance with some embodiments;

FIGS. 6A-6D respectively illustrate a user interface which can be generated by the server of FIG. 1 for managing a patient's healthcare results within the medication analysis platform system in accordance with some embodiments;

FIGS. 7A-7C respectively illustrate a user interface which can be generated by the server of FIG. 1 for sharing a patient's healthcare results within the medication analysis platform system in accordance with some embodiments;

FIGS. 8A-8B respectively illustrate a user interface which can be generated by the server of FIG. 1 for changing a patient's user settings within the medication analysis platform system in accordance with some embodiments;

FIG. 9 respectively illustrate a user interface which can be generated by the server of FIG. 1 for accessing support within the medication analysis platform system in accordance with some embodiments;

FIGS. 10A-10B respectively illustrate a user interface which can be generated by the server of FIG. 1 for scheduling a medical test within the medication analysis platform system in accordance with some embodiments;

FIGS. 11A-11C respectively illustrate portion of an example analysis report that includes detailed analysis for each medication currently taken by a patient; and

FIGS. 12A-12F respectively illustrate portion of an example analysis report that includes detailed analysis of the medication-to-medication interactions for each medication.

FIG. 13 illustrates a flow diagram of an example process for generating a detailed analysis of medication interaction for a patient.

FIG. 14 illustrates a diagrammatic representation of a machine in the example form of a computer system within which a set of instructions, for causing the machine to perform any one or more of the methodologies discussed herein, can be executed.

The same reference numbers and any acronyms identify elements or acts with the same or similar structure or functionality throughout the drawings and specification for ease of understanding and convenience.

### DETAILED DESCRIPTION

The disclosed technology includes systems, methods, apparatuses, and computer-readable mediums for facilitating electronic analysis of integrated healthcare related data and providing the integrated data in a comprehensible format for access by ordinary, non-expert individuals (“the disclosed technology”). Briefly described, the disclosed technology includes processing and aggregating, from different data sources, pharmaceutical data (e.g., medication pathways and interactions), DNA data (e.g., genetic information), medical history data, and laboratory data (e.g., patient test results), analyzing the different data to create medication pathway mappings associated with a patient's medical profile, and delivering, to the patient, real-time analysis of adverse drug interactions and/or adverse prescribed medications based on the medication pathway mappings.

In certain embodiments, the disclosed technology involves communication between an medication analysis platform system and a mobile medication analysis application installed on a patient's mobile device. The mobile medication analysis application enables the patient to access her test results (e.g., laboratory results and DNA testing results from a physician's visit) and detailed analysis associated with the test results by using her mobile device. The detailed analysis is generated by the medication analysis platform system communicating with the mobile medication analysis application. The patient is further able to input additional medications she has taken in the past, is currently taking in the present, or is planning on taking in the future (e.g., medications prescribed by another physician unknown to the system, medications taking independently by the patient, medications of interest to the patient) into the mobile medication analysis application. The mobile medication analysis application, in turn, can update the detailed analysis in real-time based on the inputted additional medications.

According to one embodiment, the medication analysis platform system generates the detailed analysis based on a comparison of the patient's medical profile with multiple other patient profiles. In the embodiment, the medication analysis platform system looks at a medication-interaction database for medication-interaction information. The medication-interaction information can be generated over time based on data from a wide range of patients that currently take medications (e.g., patients with different genotype/phenotype combinations). In generating the information for the database, the system examines DNA test results of the patient and analyzes each medication taken by the patient by looking at the primary and secondary pathways of the medication in relation to the patient's genotype and phenotype combination. The system then stores that analysis for each medication as a medication pathway mapping, so that medication pathway mapping can be auto-loaded for all future patients with the same genotype and phenotype combination. For example, if analysis of the DNA test results of a patient indicates that the patient is on Plavix® and is a poor metabolizer of that medication, the system stores that analysis for examination of a next patient. In such example, the system can auto-load the same notes (e.g., poor metabolizer of Plavix® of X and Y genotype-phenotype combination) for the medical profile and/or analysis report for that next patient.

Among other benefits, the auto-load feature based on the medication pathway mappings can save time for the system to go through the different medication interaction scenarios for each patient that needs the detailed analysis. Further, the auto-load feature enables reduction of error and provides a consistent set of analyses across the board for all patients. For example, whenever a new medication pathway mapping is created and commented on, the system saves that pathway mapping and commenting for use with other future patents. In some embodiments, the detailed analysis associated with the individual medication pathway mappings can be compiled into one report for access by the patient, e.g., a generated PDF document.

Accordingly, the disclosed technology provides a way that is easy for an ordinary individual, who is not necessarily an expert in medication interactions and DNA analysis, to access information critical in the administration and receiving of healthcare, thereby improving accurate diagnoses, reducing time and healthcare costs, and providing transparency and understanding. The ordinary individual can be the patient herself, the physician administering the healthcare, and/or friends and family members of the patient.

Various examples of the disclosed technology will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known methods, procedures, structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

As used herein, a “module,” an “interface,” a “platform,” or an “engine” includes a general purpose, dedicated or shared processor and, typically, firmware or software modules that are executed by the processor. Depending upon implementation-specific or other considerations, the module, interface, platform, or engine can be centralized or its functionality distributed. The module, interface, platform, or engine can include general or special purpose hardware, firmware, or software embodied in a computer-readable (storage) medium for execution by the processor. As used herein, a computer-readable medium or computer-readable storage medium is intended to include all media that are statutory (e.g., in the United States, under 35 U.S.C. §101), and to specifically exclude all media that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

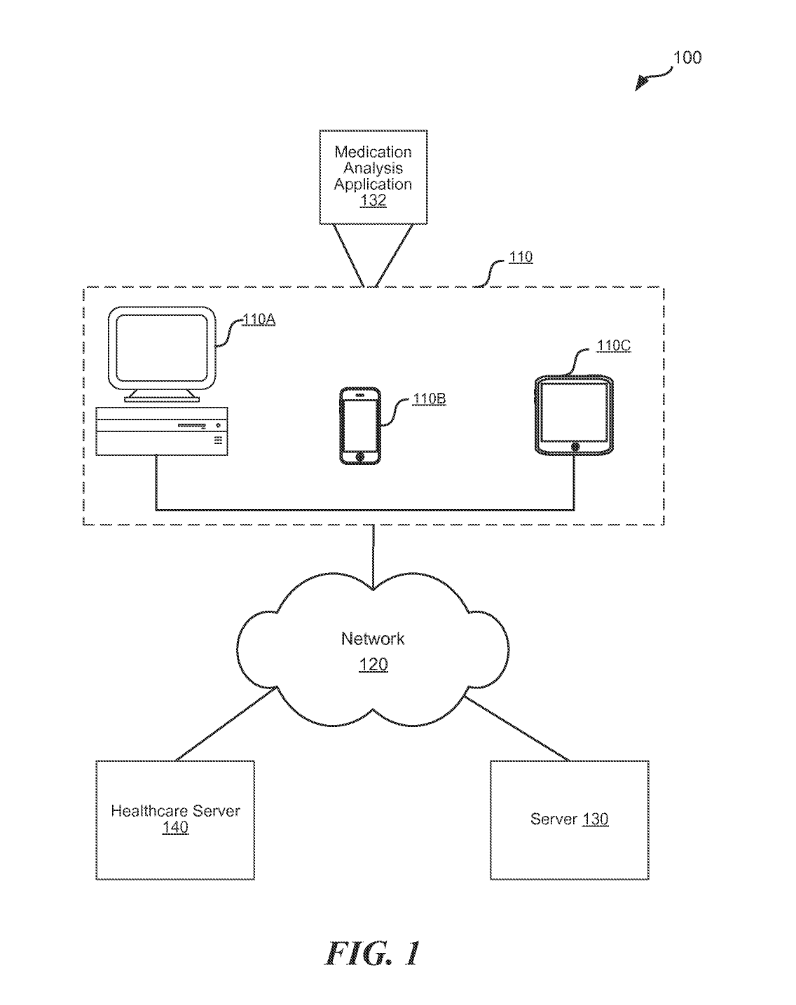

FIG. 1 illustrates a representative computer network environment 100 within which some embodiments may be implemented. The environment 100 includes a client device 110 (e.g., client device 110A, 1108, and 110C), a network 120, a server 130, and a remote healthcare server 140. The client device 110, the server 130, and the remote healthcare server 140 are coupled in communication for data transmission over the network 120. For example, the components may be connected via a twisted pair cabling network, a coax cable network, a telephone network, or any suitable type of connection network. In some embodiments, the network 120 may be wireless (e.g., which may include an IEEE 802.11 wireless network, or a data traffic network based on wireless telephony services such as 3G, 3.5G, 4G LTE and the like). The technologies supporting the communications between the client 110 and server 130 may include Ethernet (e.g., as described in IEEE 802.3 family of standards) and/or other suitable types of area network technologies. Note that the components of FIG. 1 are just one implementation of the computer network environment within which present embodiments may be implemented, and the various alternative embodiments are within the scope of the present embodiments. For example, the network 120 may include intervening devices (e.g., switches, routers, hubs, etc.) in the network 120. In some examples, the network 120 comprises the Internet.

The server 130 may be one or more server computers or work stations that are employed by an organization for hosting a platform that functions as a channel to client users for accessing healthcare related information (e.g., medical history records, laboratory test results, DNA test results, medication-interaction information, etc.) and performing one or more tasks associated with the administration of healthcare to patients (e.g., analyzing and presenting detailed analysis relating to medication interactions). The platform hosted by the server 130 may be executed in the form of a medication analysis application 132 that can be accessible by the client device 110. The medication analysis application 132 may be a mobile application installed on a mobile device (e.g., client device 1108) or a conventional software application installed on a convention computing device, such as a personal computer (PC) (e.g., client device 110A).

The server 130 typically includes at least one processor and a memory, and may be further connected to one or more computers (not shown in FIG. 1 for simplicity) that carry out the various healthcare related functions via the network 120. The server 130 is also typically equipped with or is coupled to one or more databases (e.g., repository 205 of FIG. 200) for storing the various healthcare related data (e.g., medical health records, DNA findings, general medical information, analysis data, etc.) and/or data for hosting the platform that facilitates the healthcare related tasks. The one or more databases can include, for example, one or more hard drives (which may be further coupled together using RAID-0, 1, 5, 10, etc.), a centralized or distributed data cluster, a cloud-storage service provider, or other suitable storage systems suitable for storing digital data. The data contained in these databases is highly confidential, and as such the secure communication to access these databases includes at least a 256 bit encryption and employs an SSL if using an Internet based communication means.

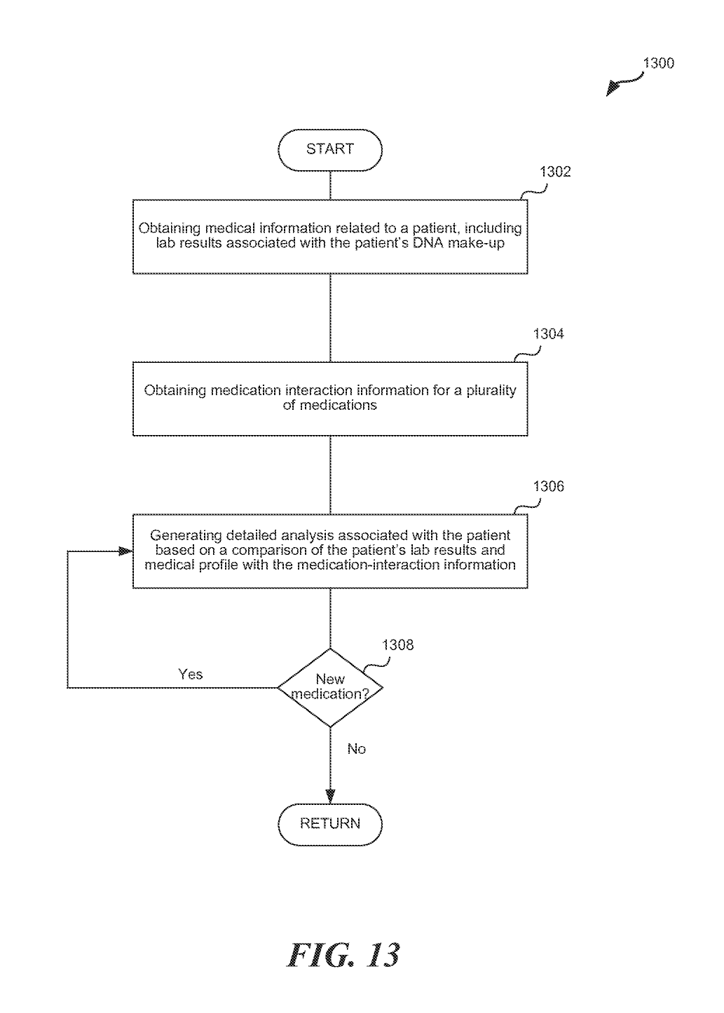

The server 130 can include a communication interface (e.g., network interface 1312, FIG. 13) that enables secure communication between the server 130 and a variety of authorized users. As used here, the term “variety of authorized users” refers to one or more healthcare systems (e.g., a physician's medical health records computer system, a testing laboratory's medical health records computer system, a research laboratory's records computer system, etc.) and an identified recipient, such as, but not limited to, one or more healthcare system employed physicians/providers, patients, the CEO and the healthcare institution administration staff, non-employed affiliated physicians/providers and other healthcare professionals.

As used here, a “healthcare system” refers to any institution that administers or facilitates healthcare-related services including, for example, a test laboratory, a hospital, a group of hospitals, a physician group practice, an HIE, an HMO, an ACO, a Community Health Center, an insurance company, any institution that is affiliated with a healthcare system, or any other combination of the aforementioned institution(s). In some embodiments, the healthcare system can employ one or more server computers or work stations working in coordination to provide a channel for mediate data with other servers (e.g., the server 130). In the illustrated embodiment of FIG. 1, the healthcare system is the remote healthcare server 140, although other configurations are possible in other embodiments.

As used here, the term “physician/provider” refers to any State or Federal licensed medical practitioner such as, but not limited to, Medical Doctors (MD), Doctors of Osteopathy (DO), Dentists (DDS & DMD), and practitioners of Complementary and Alternative Medicine (CAM) such as, but not limited to, primary care physicians and specialty physician/practitioners such as, but not limited to, cardiologists, pulmonologists, nephrologists, neurologists, endocrinologists, gastroenterologists, dermatologists, general surgeons, ENT surgeons, cardio-thoracic surgeons, vascular surgeons, ophthalmologists, obstetricians, colorectal surgeons, dentists, oral surgeons, orthopedists, neurosurgeons, podiatrists, psychiatrists, chiropractors, acupuncturists and others, or any combination(s) thereof. The term “physician/provider” may also, for instance, refer to medical practitioners not having MD, DO, DDS, DMD or DPM licenses such as, but not limited to, dentists, optometrists, pharmacists, respiratory therapists, occupational therapists, nurses, physician extenders, nurse practitioners, physician assistants and others, healthcare professionals, or any combination(s) thereof.

The server 130 communicates with the variety of authorized users to receive information from their respective computer systems. The server 130 further provides for the delivery of healthcare related information about a patient (e.g., medical history, recent laboratory tests conducted, current list of medications, etc.) along with detailed analysis information to the variety of authorized users. By having a readily available platform with information about the patient, the physicians, providers, the patients themselves, and/or other identified recipient can have a visual representation in real time of data, such as predicted adverse reactions to medications, current adverse reactions to medications (e.g., patient is a poor metabolizer of Plavix®), patient's DNA findings (e.g., genotype/phenotype), patient's scheduled visits to a healthcare facility, amongst many others. This data can be accessible to help seek out, identify, and/or rectify problem areas in administering healthcare to patients (and/or self-administration of healthcare by the patients themselves).

The client device 110, which may be used by a client user to communicate with the server 130 in accessing the healthcare related data access (e.g., through the medication analysis application 132), may include a laptop, a desktop, a tablet, a personal computer, a personal digital assistant (“PDA”), a smart phone, and the like. The client user can be any of the variety of authorized users discussed above. The client device 110 typically includes a display that can be used to display a user interface, and may include suitable input devices (not shown for simplicity) such as a keyboard, a mouse, or a touchpad. In some embodiments, the display may be a touch-sensitive screen that includes input functionalities.

Furthermore, although the server 130 is illustrated in FIG. 1 (as well as described throughout the present disclosure) as a separate entity from the client device 110, it is noted that in some specific embodiments, both the client device 110 and the server 130 can be implemented in the same computing device such as a smart phone or a tablet computer so that the standalone computing device can be the sole host of the environment 110 and practice the various techniques disclosed herein.

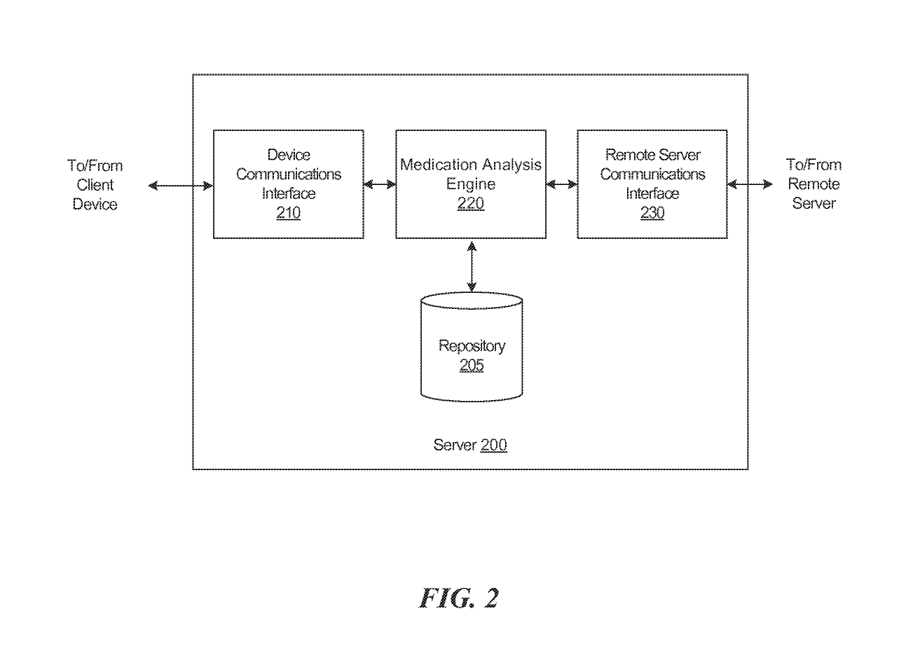

FIG. 2 illustrates a block diagram further explaining certain components and functionalities thereof in a server 200, which can be the server 130 of FIG. 1 in accordance with some embodiments. The server 200 includes a device communications interface 210, a medication analysis engine 220, and a remote server communications interface 230. The example server 200 includes various modules and storage as described below.

The device communications interface 210 is configured facilitate communications with a client device, such as the client device 110 of FIG. 1. For example, the device communications interface 210 can receive an access request initiated by the client device (e.g., by a patient accessing a mobile medication analysis application) that includes a request for medication analysis information provided by the server 200. Additionally, the device communications interface 210 can provide patients with an ability to submit additional information to improve the medication analysis generated by the server 200. The additional information can include any medication not already captured by the server 200. The server 200 also allows the patient to share the medication analysis and/or any other healthcare related information provided by the server 200 with other friends, family members, and/or physicians (e.g., provide access to other client devices accessible to these individuals).

The medication analysis engine 220 is configured to process DNA test results of a patient to provide detailed analysis for the medications taken by the patient and/or planned to be taken. The medication analysis engine 220 can access a patient's DNA test results to analyze her reaction to one or more medications being currently taken and/or will be taken. Further, the medication analysis engine 220 can determine medication-to-medication interaction(s) between medications currently taken by a patient.

The server 200 can store the detailed analysis information in a repository 205. The detailed analysis information can include a variety of information about patients including for example, healthcare related information, such as their list of medications, medication pathway mappings, and effects on the patients, configuration information for operating the medication analysis application, such as authorized users (e.g., shared family members), user profile information, such as patient contact information, email addresses, passwords, and the like. The repository 205 can include one or more databases which include, for example, one or more hard drives (which may be further coupled together using RAID-0, 1, 5, 10, etc.), a centralized or distributed data cluster, a cloud-storage service provider, or other suitable storage systems suitable for storing digital data. The data contained in these databases is highly confidential, and as such the secure communication to access these databases includes at least a 256 bit encryption and employs an SSL if using an Internet based communication means.

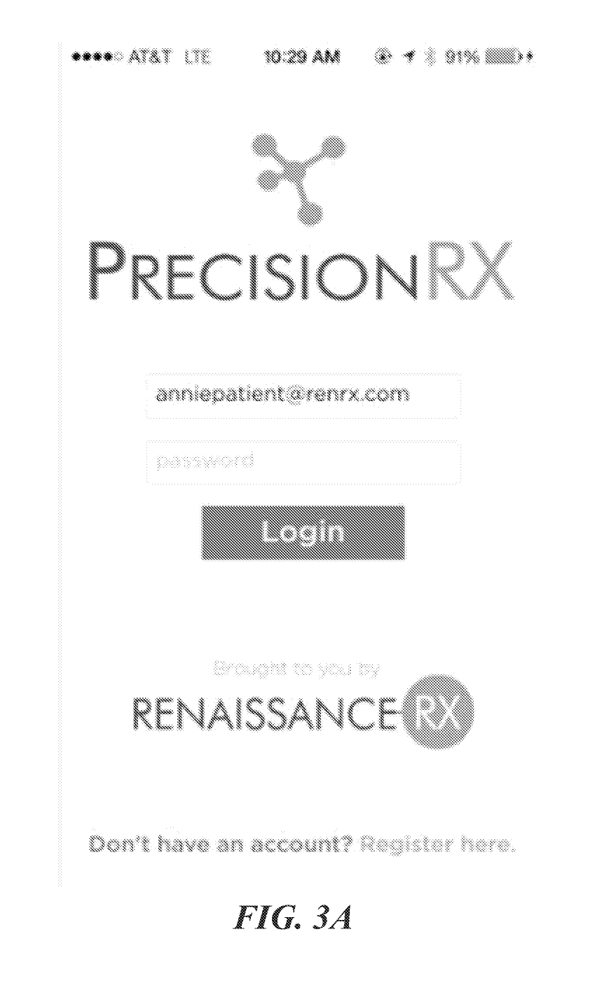

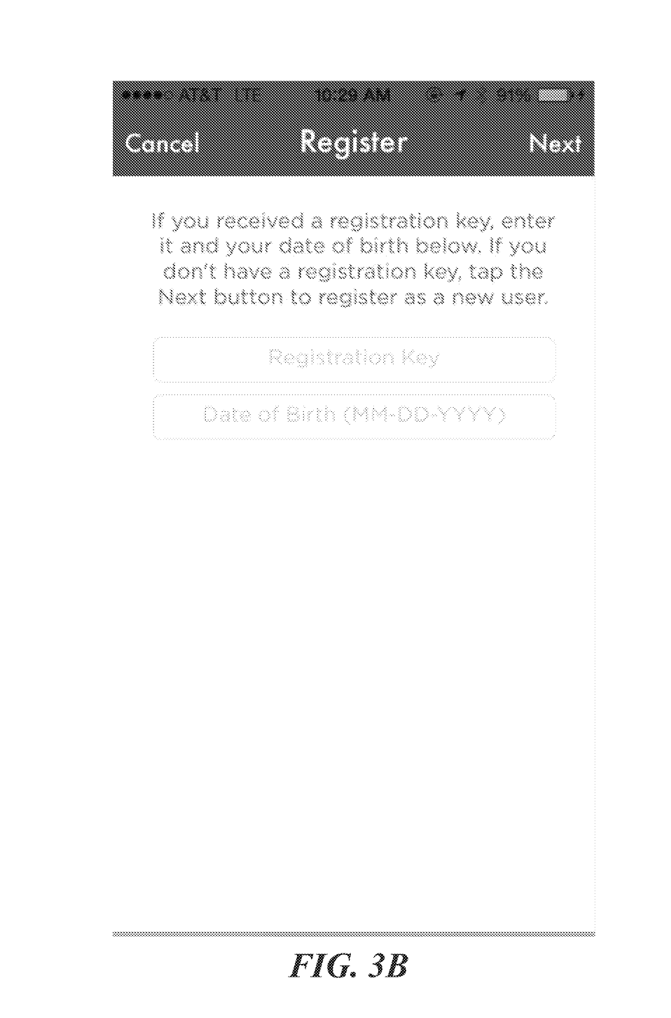

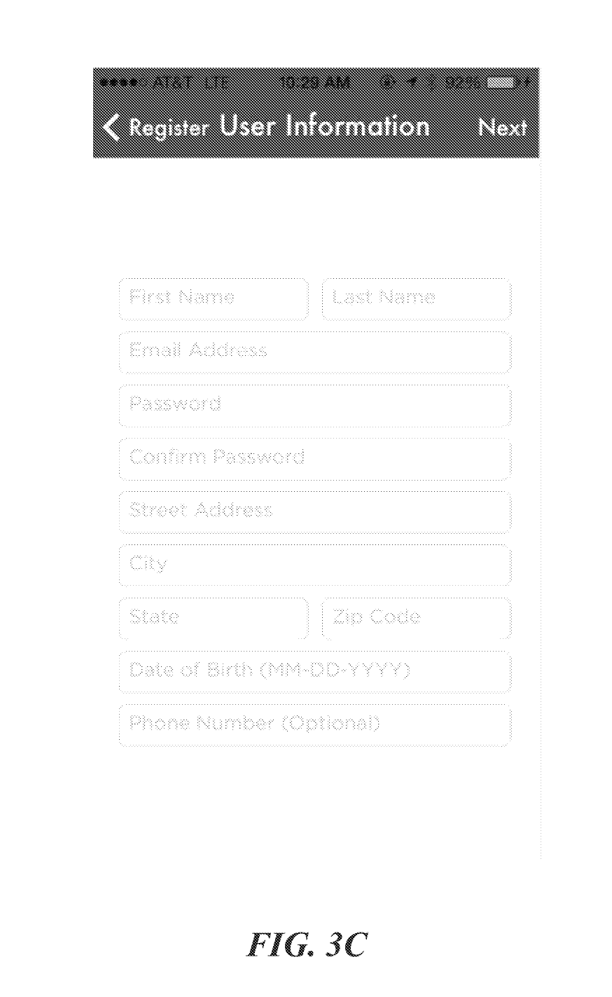

FIGS. 3A-10B respectively illustrate various user interfaces that can be generated by the server 130 of FIG. 1 for facilitating a mobile medication analysis application installed on a patient's mobile device, in accordance with some embodiments of the disclosed technology. For ease of discussion in the FIGS. 3-10, consider the following example scenario of a user “Patient Annie” accessing the mobile medication analysis application installed on her mobile device (e.g., client device 110B), where the mobile medication analysis application is the medication analysis platform system executed under instructions from the server 130.

FIGS. 3A-3C respectively illustrate the user interface for facilitating a login to the medication analysis platform system in accordance with some embodiments. In one embodiment, Patient Annie can log into the system using her personal email address (e.g., anniepatient@renrx.com) if she has already signed up for an account, as illustrated in FIG. 3A. If Patient Annie does not have an account, she may register for one using a registration key, as illustrated in FIG. 3B. In one example, after Patient Annie gets a DNA test, e.g., from a DNA test laboratory, the laboratory mails the results, along with a registration card, to Patient Annie. The “mail” can be in paper form (e.g., postal mail) or electronic form (e.g., e-mail). The registration card includes a link for how to download a mobile medication analysis application, e.g., an iPhone® app from the App Store®, as well as a registration key. When Patient Annie first goes to use the medication analysis application, she can input the registration key, which allows the medication analysis application to look up Patient Annie's test results and pre-populate Patient Annie's user information. After such pre-population, Patient Annie will only have to fill out any user information that has not been submitted to the DNA laboratory (e.g., email address, password, etc). If Patient Annie does not have a registration key, she may register by simply inputting her information, as illustrated in FIG. 3C.

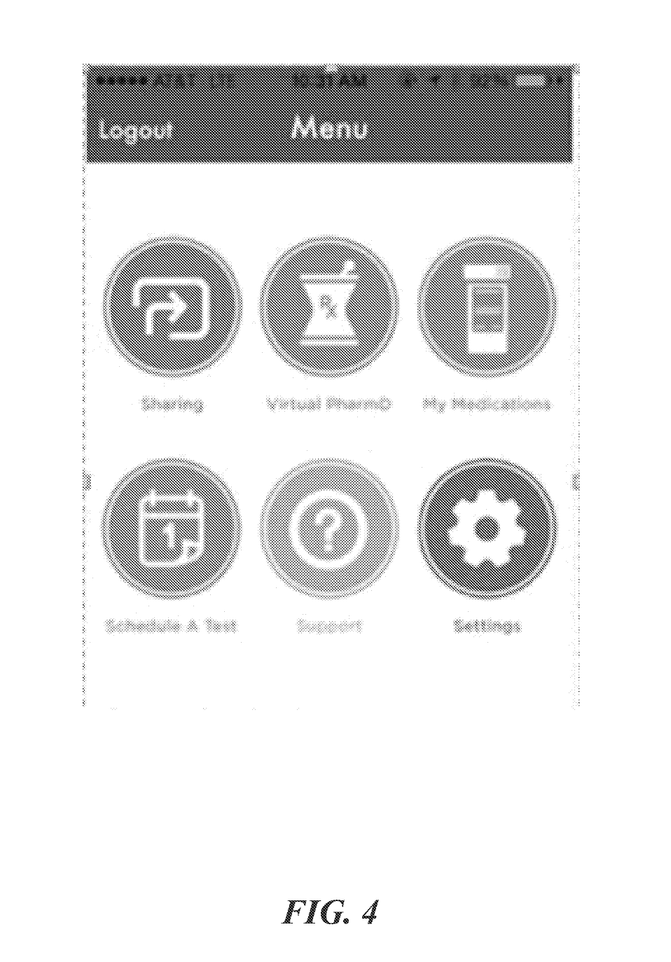

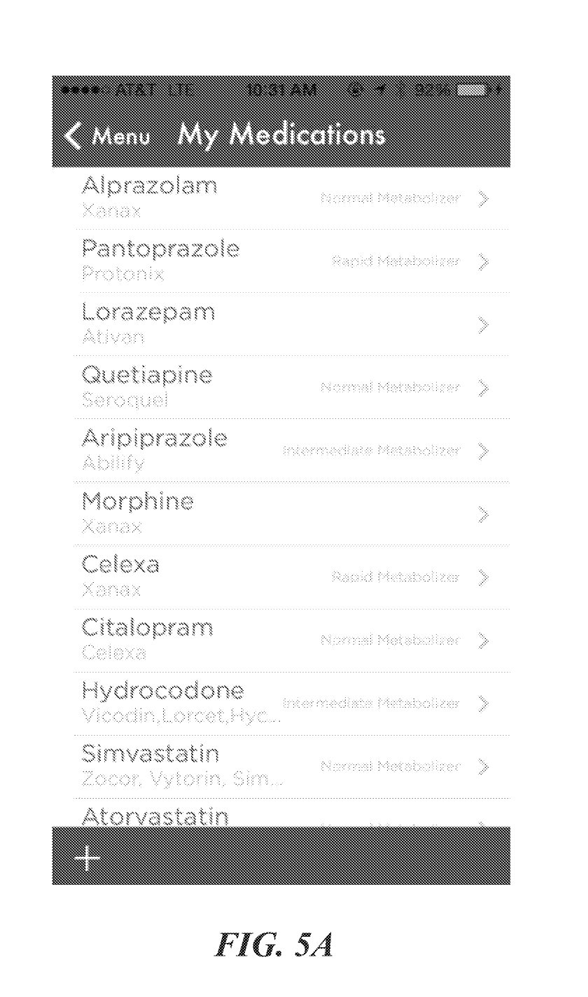

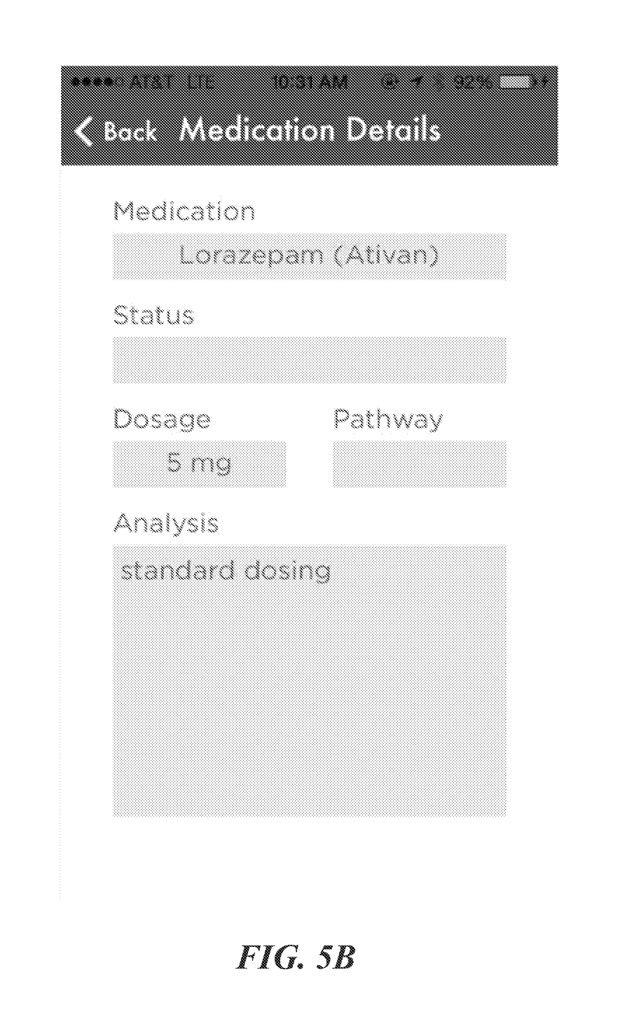

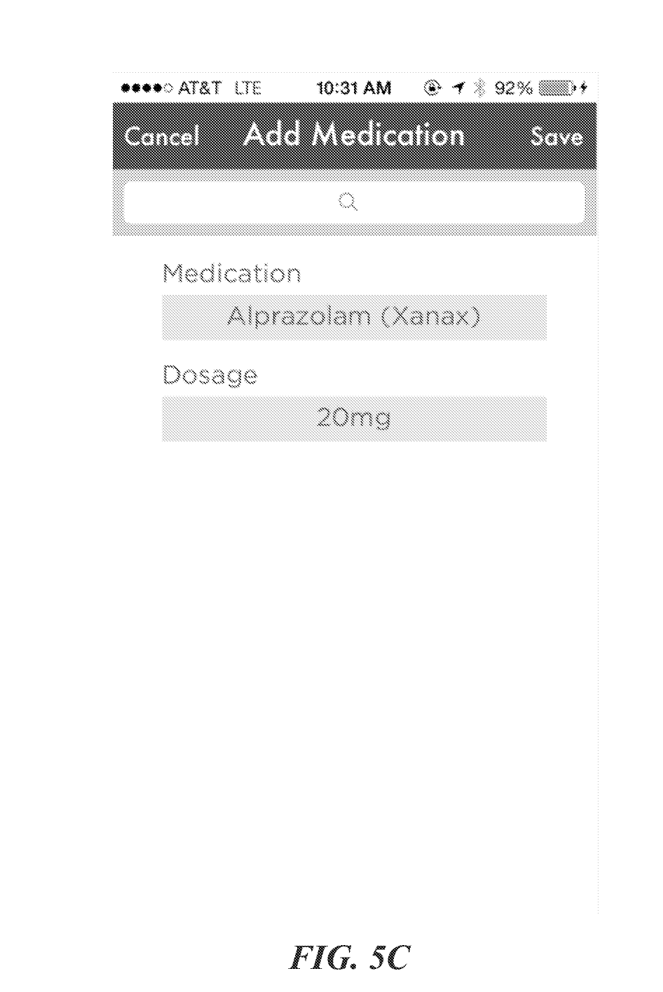

FIG. 4 illustrates the user interface that can be generated by the server of FIG. 1 for accessing various features of the medication analysis platform system in accordance with some embodiments. As shown in FIG. 4, Patient Annie can view her current list of medications, detailed analysis associated with those medications, share the detailed analysis, and/or schedule a medical test (e.g., in response to after viewing the detailed analysis). In some embodiments, Patient Annie can also change her user settings and ask for help/support within the application. Each of the features of the medication analysis platform system will be explained in further detail with respect to FIGS. 5A-11 below.

FIGS. 5A-5C respectively illustrate the user interface that can be generated by the server of FIG. 1 for managing medications within the medication analysis platform system in accordance with some embodiments. Patient Annie can click on the “My Medications” icon from the main “Menu” user interface illustrated in FIG. 4 to view her current list of medications illustrated in FIG. 5A. In some embodiments, Patient Annie can also view a list of past medications by clicking on “My Medications.”

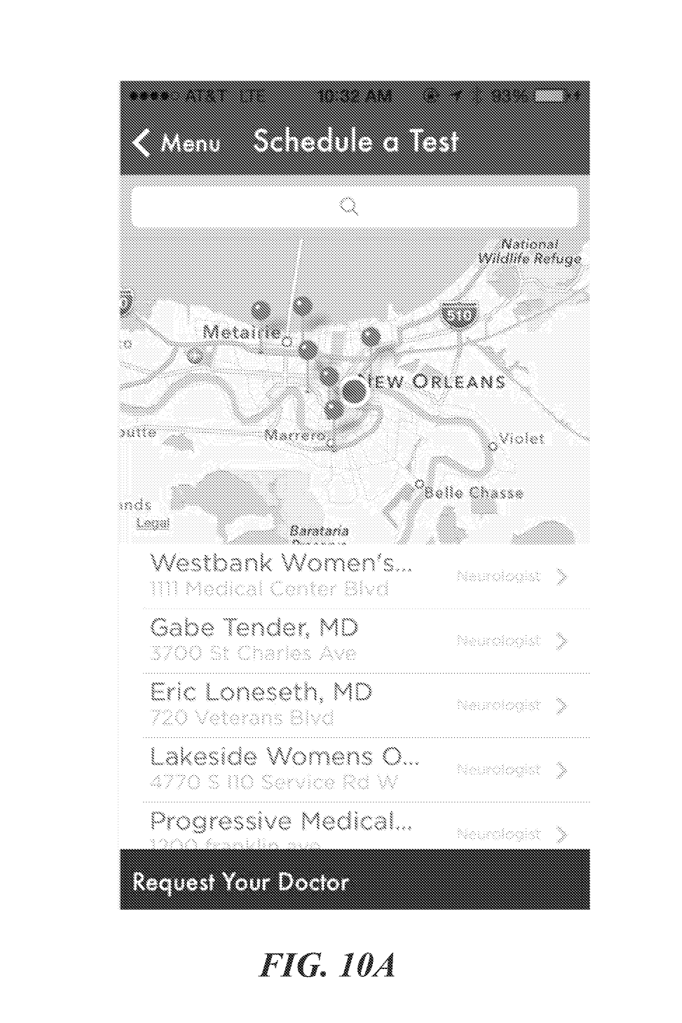

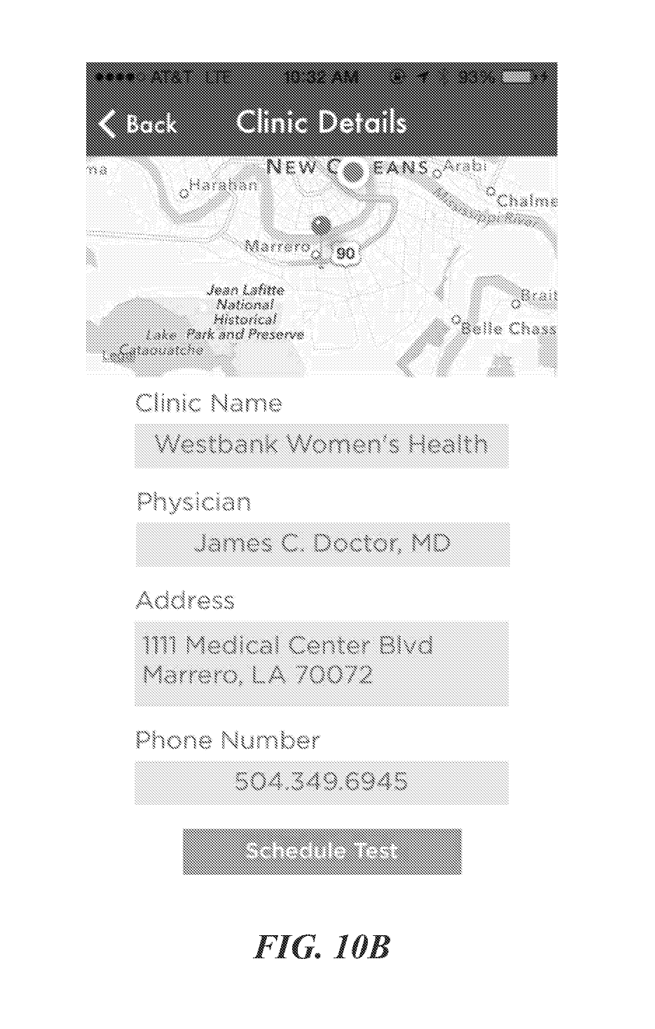

As illustrated in FIG. 5A, upon clicking on “My Medications,” Patient Annie can view each medication (e.g., Pantoprazole) with its associated effect (e.g., Rapid Metabolizer) generated based on Patient Annie's genotype. Patient Annie can view the details about each medication. Some medications may not already have the detailed analysis, as illustrated in FIG. 5B. This may be because, for example, Patient Annie may not have gone through a DNA testing. In such example, Patient Annie, upon seeing this information, may choose to schedule a test using the user interfaces illustrated in FIGS. 10A-10B. While viewing the list of current and past medications, Patient Annie can add additional medications, as illustrated in FIG. 5C.

In some embodiments, the server 130 generates a medication adverse interaction alert in response to a new medication added by Patient Annie. This alert can be in the form of a push notification, an icon badge, a banner, etc. The alert informs Patient Annie that the new medication will likely have an adverse effect on her. For example, the new medication, if taken with an existing medication, will likely have X result. In such example, the server 130 can also display to Patient Annie which existing medications have an adverse interaction with the new medication. In another example, the new medication will likely have Y result (regardless of existing medications) based on Patient Annie's DNA.

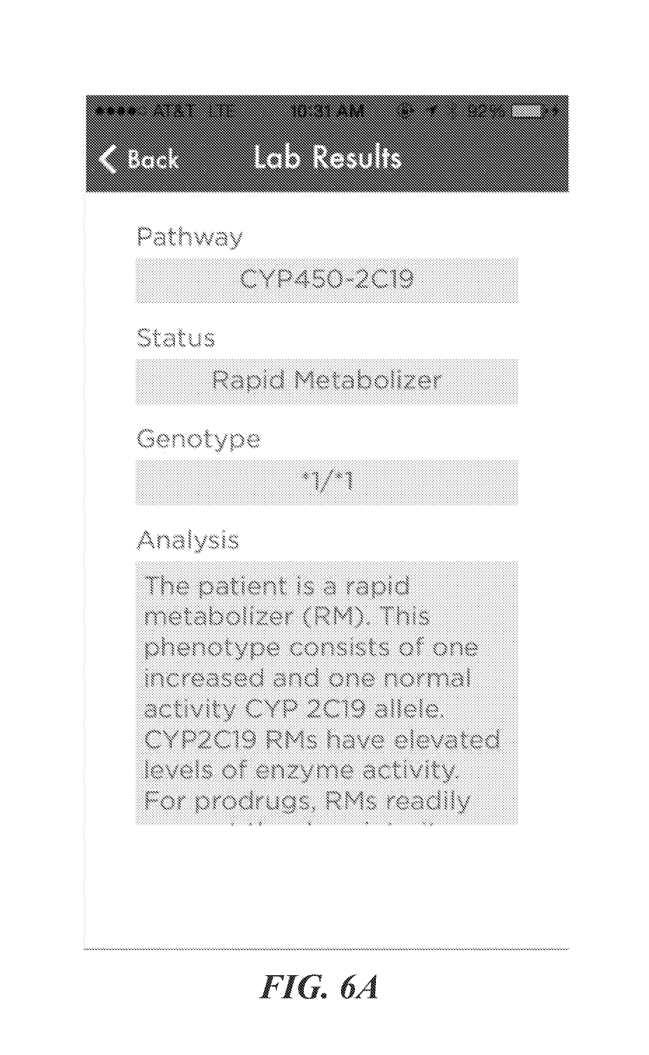

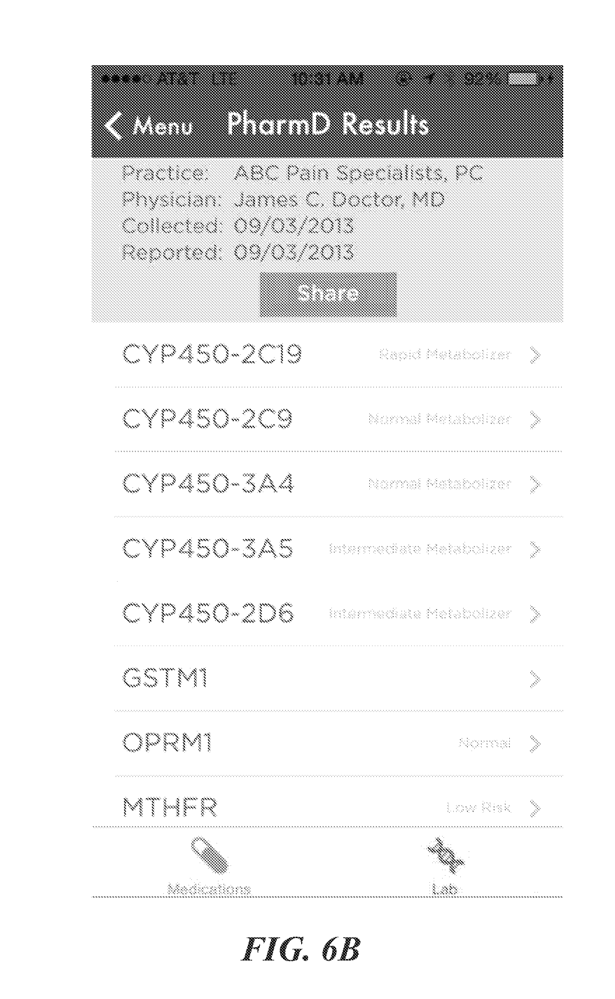

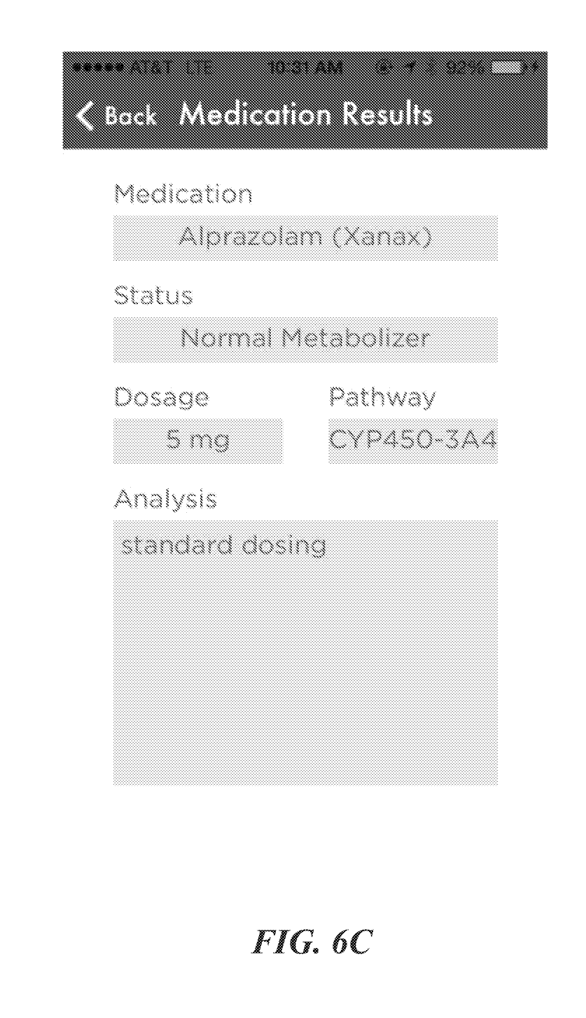

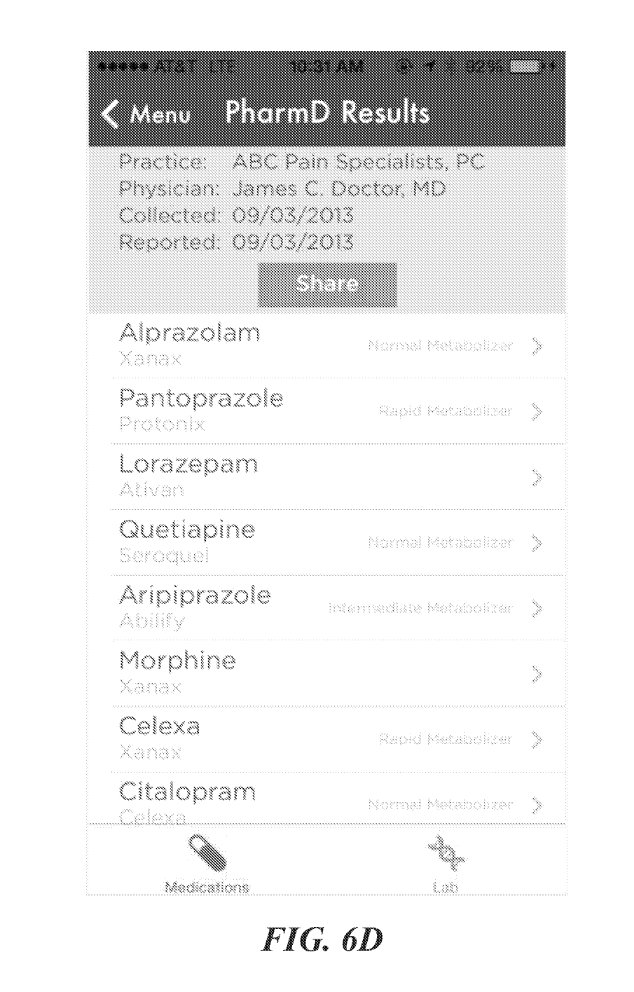

FIGS. 6A-6D respectively illustrate a user interface which can be generated by the server of FIG. 1 for managing a patient's healthcare results within the medication analysis platform system in accordance with some embodiments. Patient Annie can click on the “Virtual PharmD” icon from the main “Menu” user interface illustrated in FIG. 4 to access detailed analysis associated with her health.

FIG. 6A illustrates “Lab Results” that are generated based on Patient Annie's DNA. As used here, the term “Lab Results” refer to the overall results of the individual pathways for a patient (e.g., pathway CYP450-2D6 is metabolized in X manner for the patient).

Examples of the genotype and phenotype combinations and pathways are listed below in Table 1.

TABLE 1

CYP450-2C19 Intermediate Metabolizer
CYP450-2C19 Normal Metabolizer
CYP450-2C19 Normal-Intermediate Metabolizer
CYP450-2C19 Poor Metabolizer
CYP450-2C19 Rapid Metabolizer
CYP450-2C19 Ultra-Rapid Metabolizer
CYP450-2C9 Intermediate Metabolizer
CYP450-2C9 Normal Metabolizer
CYP450-2C9 Poor Metabolizer
CYP450-2D6 Intermediate Metabolizer
CYP450-2D6 Normal Metabolizer
CYP450-2D6 Poor Metabolizer
CYP450-2D6 Poor Metabolizer
CYP450-2D6 Ultra-Rapid Metabolizer
CYP450-3A4 Intermediate Metabolizer
CYP450-3A4 Normal Metabolizer
CYP450-3A4 Poor Metabolizer
CYP450-3A5 Intermediate Metabolizer
CYP450-3A5 Normal Metabolizer
CYP450-3A5 Poor Metabolizer
Factor II (prothrombin)
Intermediate Thrombosis Risk
Factor II (prothrombin)
Normal Thrombosis Risk
Factor V Leiden Intermediate Thrombosis Risk
Factor V Leiden Normal Thrombosis Risk
MTHFR High Risk
MTHFR High Risk
MTHFR High Risk - Rare
MTHFR Low Risk
MTHFR Low Risk
OPRM1 Moderate
OPRM1 Normal
OPRM1 Poor
VKORC1 High Warfarin Sensitivity
VKORC1 Intermediate Warfarin Sensitivity
VKORC1 Low Warfarin Sensitivity

FIG. 6B illustrates “PharmD Results” to show the results of Patient Annie's DNA test illustrating the list of all the pathways Patient Annie is affected by and how they affect Patient Annie. In the embodiment of FIG. 6B, these “PharmD Results” are illustrated under the “Lab” tab of the mobile medication analysis application, although alternative configurations are available in other embodiments. For example, in some embodiments, the title “PharmD Results” of FIG. 6B can be called “DNA Results” or “Test Results.”

FIG. 6C illustrates “Medication Results” that are displayed to show Patient Annie a user manageable list of any and all medications she may be taking. Consider one scenario in which Patient Annie visits an office of a physician, and the physician wants to prescribe Patient Annie a new medication. Consider another scenario in which Patient Annie visits a pharmacy to pick up a new over-the-counter medication. In either of the scenarios, Patient Annie can launch the medication analysis application on her device, e.g., a smartphone, add the particular medication and dosage she is/will be taking. Once that medication is submitted, the medication analysis application generates detailed analysis for that medication, and Patient Annie will be able to see, in real-time, how she metabolizes that medication based on her past DNA test(s). For example, Patient Annie purchases Zyrtec at a pharmacy (which Patient Annie was not taking at the time of her DNA testing). In such example, Patient Annie can add Zyrtec into the medication analysis application, and based on the DNA test she already took, she can see how Zyrtec will affect her.

FIG. 6D illustrates “PharmD Results” to show a list of the medications Patient Annie is currently taking (at the time of the DNA test), the pathways the medications are affected by, and how Patient Annie will metabolize each medication based on that pathway. For example, Patient Annie is taking Xanax, which is affected by pathway CYP450-3A4, and Patient Annie is a normal metabolizer of that pathway. As such, Patient Annie is shown as a normal metabolizer of Xanax.

Note that the illustrated embodiment of FIG. 6B shows all the pathways Patient Annie is affected by, and that the illustrated embodiment of FIG. 6D, in contrast, shows the pathways specific to Patient Annie's current list of medications at the time of the DNA test. The “PharmD Results” of FIGS. 6B and 6D can be configured in alternative embodiments other than those illustrated respectfully in those figures. For example, the title “PharmD Results” of FIG. 6B can be called “DNA Results” or “Test Results” under the “Lab” tab, and the “PharmD Results” of FIG. 6D can remain the same and the tab “Medications,” in such scenario of FIG. 6D, can be changed to “PharmD.”

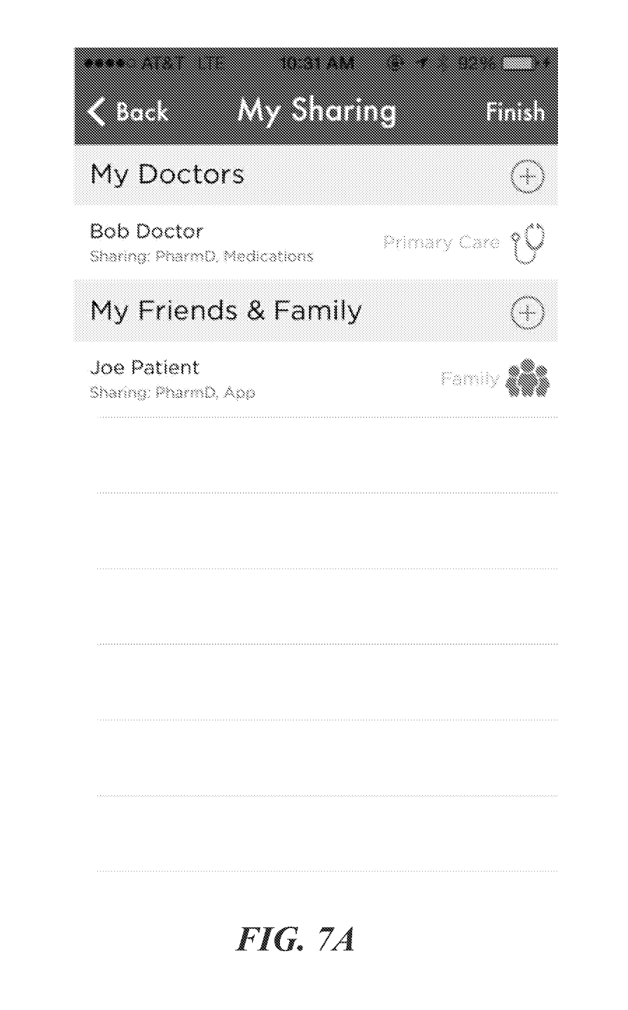

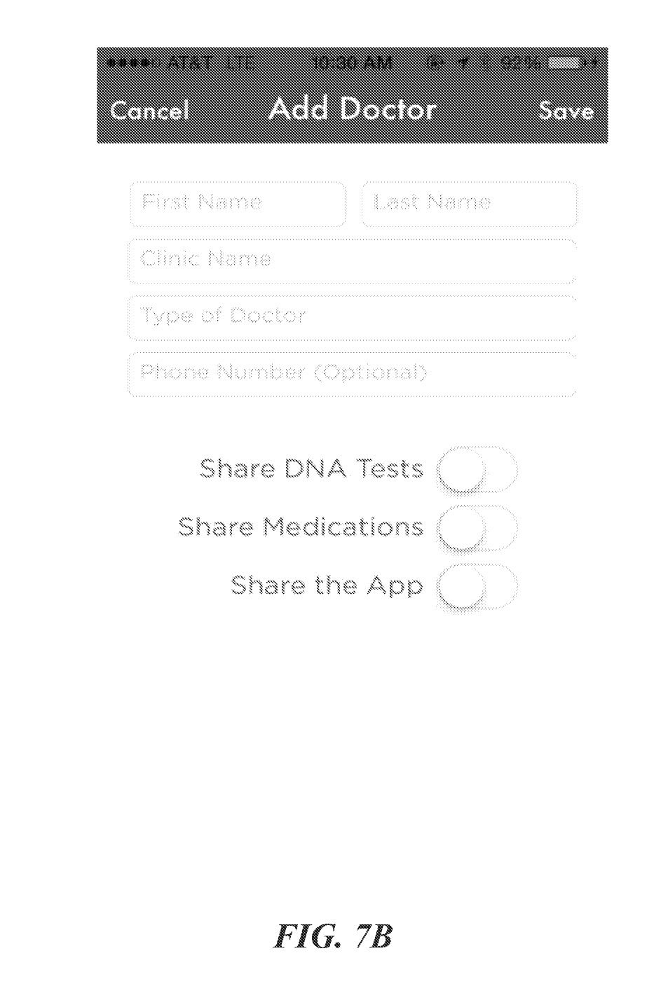

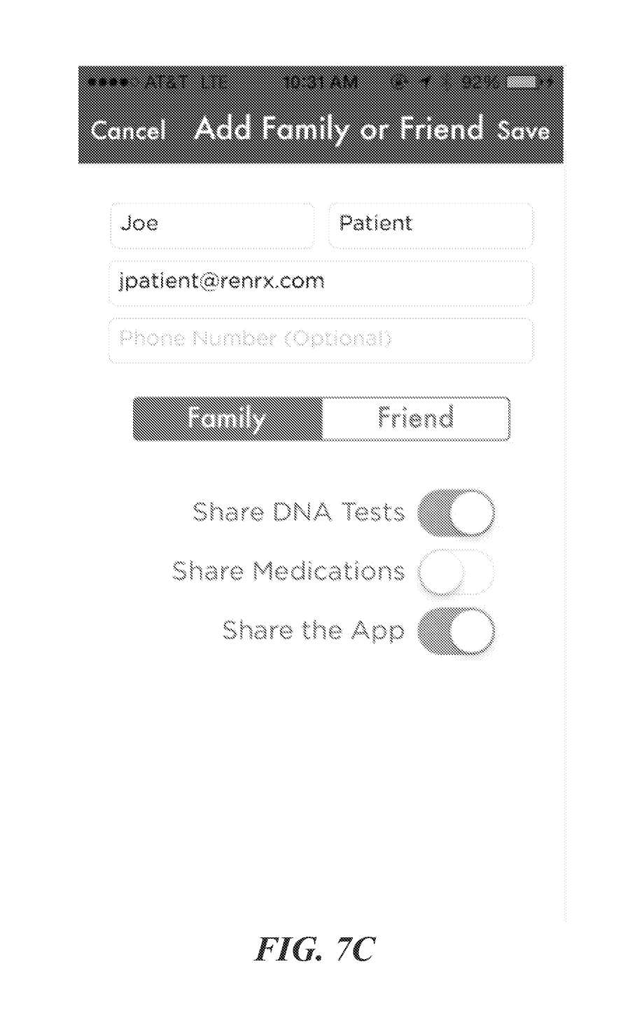

FIGS. 7A-7C respectively illustrate a user interface which can be generated by the server of FIG. 1 for sharing a patient's healthcare results within the medication analysis platform system in accordance with some embodiments. Patient Annie can click on the “Sharing” icon from the main “Menu” user interface illustrated in FIG. 4 to start sharing her healthcare related information, e.g., with friends, family members, and/or physicians. As illustrated in FIG. 7A, Patient Annie can view the individuals with whom she is sharing her healthcare related information, such as her DNA test results, lab results, list of medications, and/or detailed analysis associated with those items.

Patient Annie can add a physician, e.g., the primary physician, to share the data associated with a visit to a specialist physician, by using the user interface illustrated in FIG. 7B. According to one embodiment illustrated in FIG. 7B, Patient Annie can share her DNA tests, her medications, and/or all data on the entire application (i.e., the medication analysis platform system). Similarly, Patient Annie can add a family member or friend to share her DNA tests, medications, and/or all data on the entire application, as illustrated in FIG. 7C.

Patient Annie, for example, can take advantage of the “Sharing” feature of the application by inputting all of her different physicians. In response, the application can send out reports to all of those physicians so they have the same healthcare information about Patient Annie. In a future event, for example, a Physician X, who is listed as Patient Annie's physician, would immediately get Patient Annie's test results right after the test is conducted at a Physician Y's office, thereby allowing both doctors to know about Patient Annie's medical condition(s).

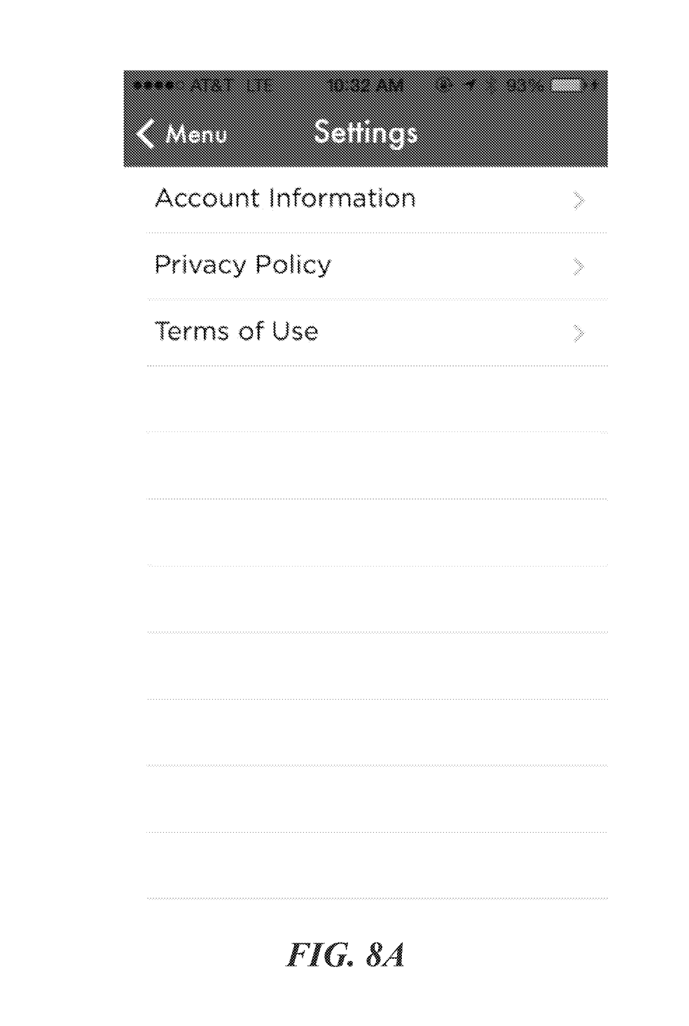

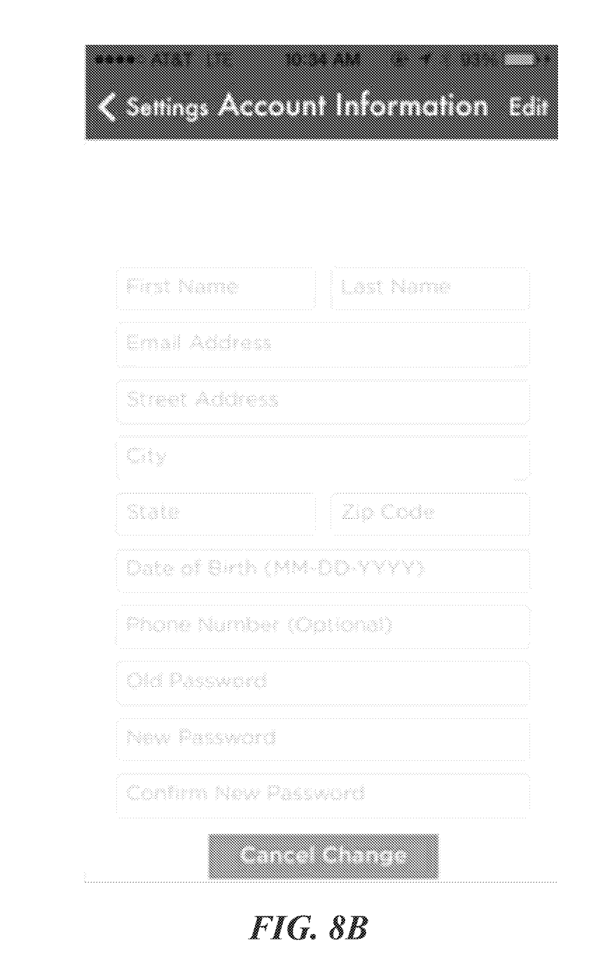

FIGS. 8A-8B respectively illustrate a user interface which can be generated by the server of FIG. 1 for changing a patient's user settings within the medication analysis platform system in accordance with some embodiments.

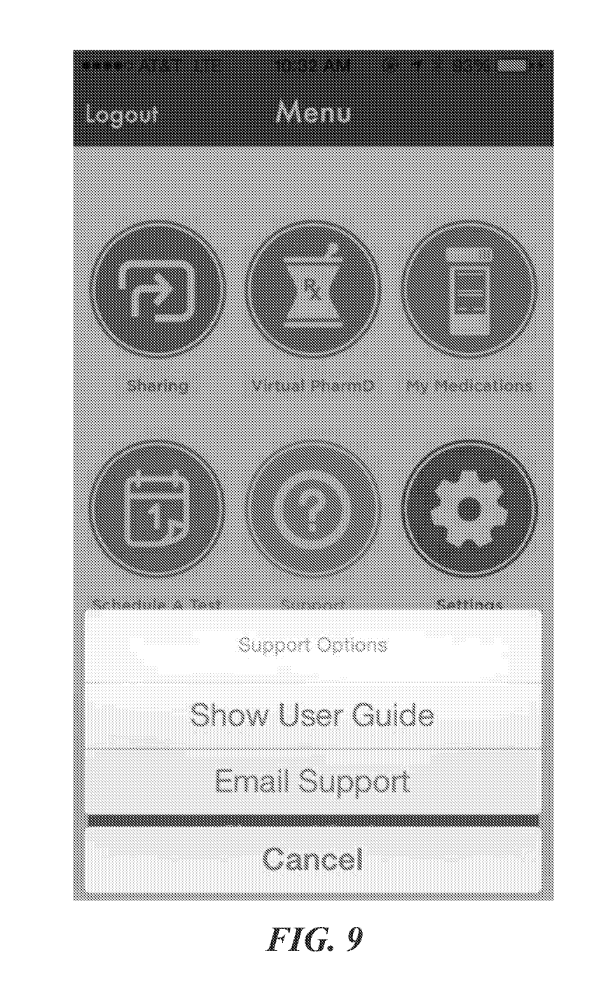

FIG. 9 respectively illustrate a user interface which can be generated by the server of FIG. 1 for accessing support within the medication analysis platform system in accordance with some embodiments.

FIGS. 10A-10B respectively illustrate a user interface which can be generated by the server of FIG. 1 for scheduling a medical test within the medication analysis platform system in accordance with some embodiments. Patient Annie can search for nearby medical facilities and/or medical facilities at a particular location, as illustrated in FIG. 10A. Further, Patient Annie can view details of each medical facility.

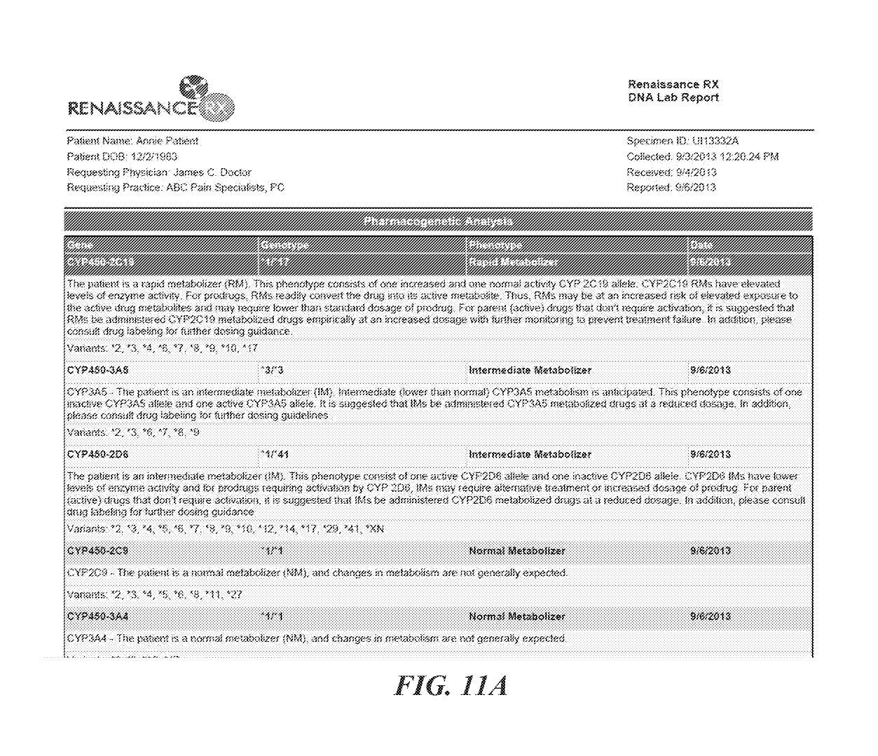

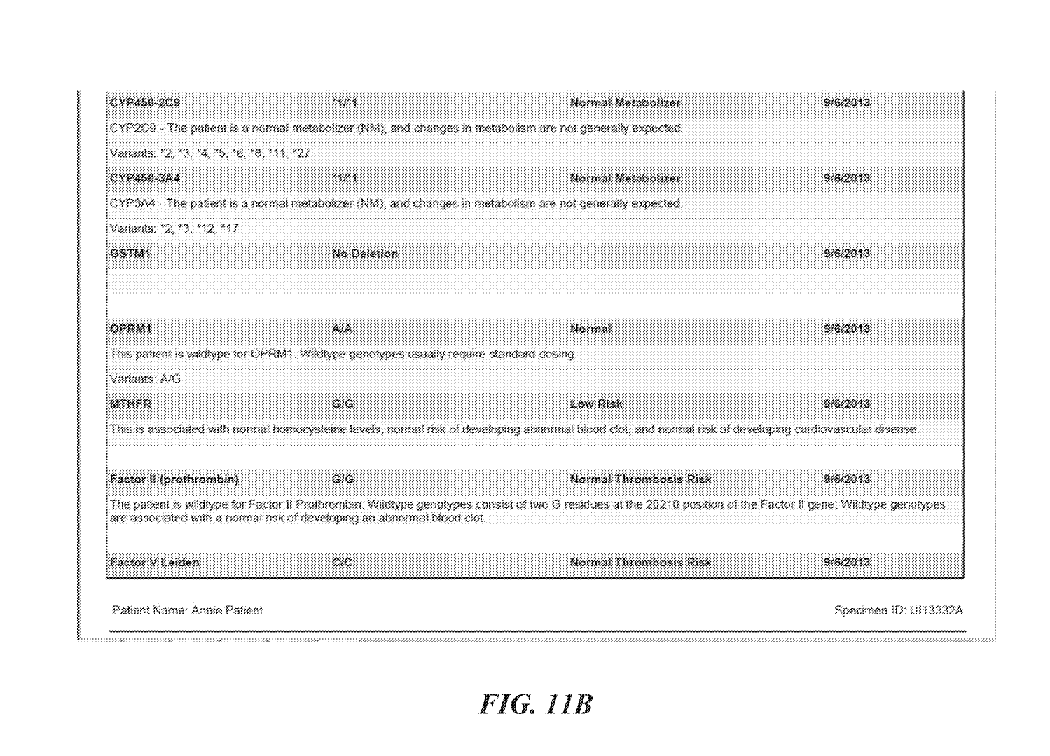

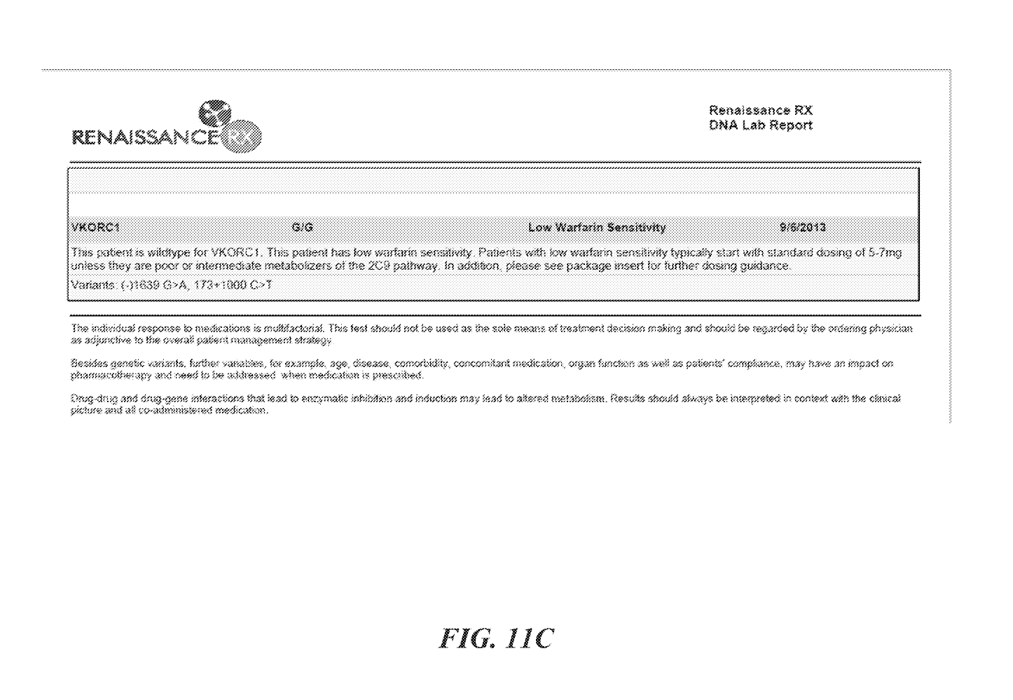

FIGS. 11A-11C respectively illustrate portion of an example analysis report that includes detailed analysis for each medication currently taken by Patient Annie. The detailed analysis includes, for each medication, the pathways and associated effect.

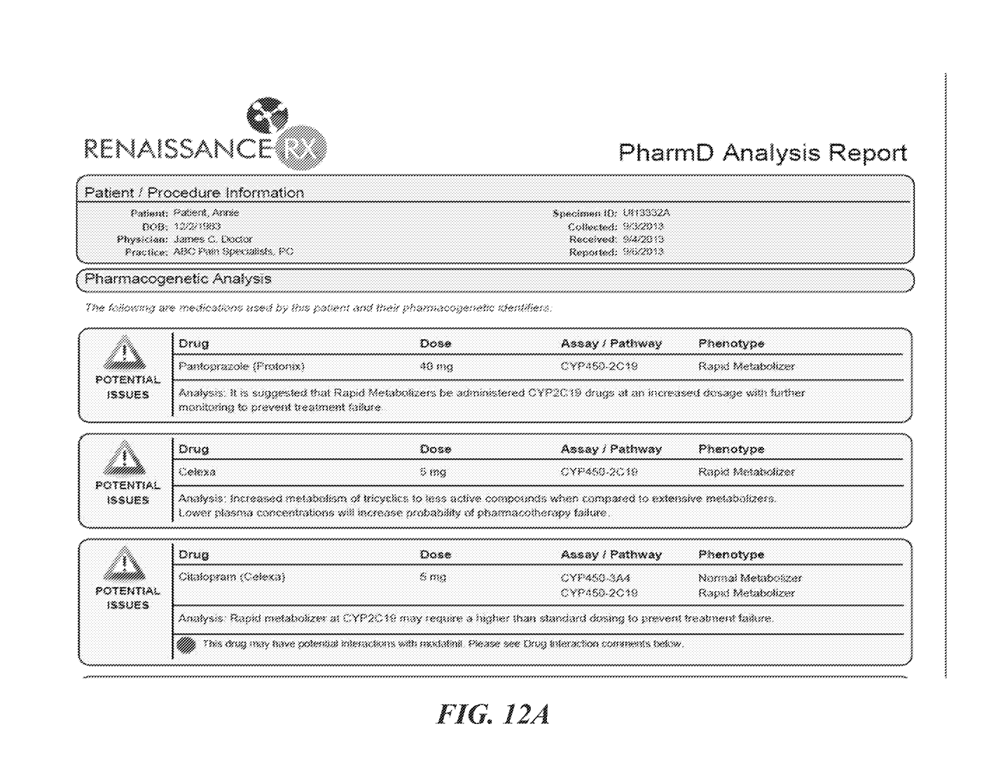

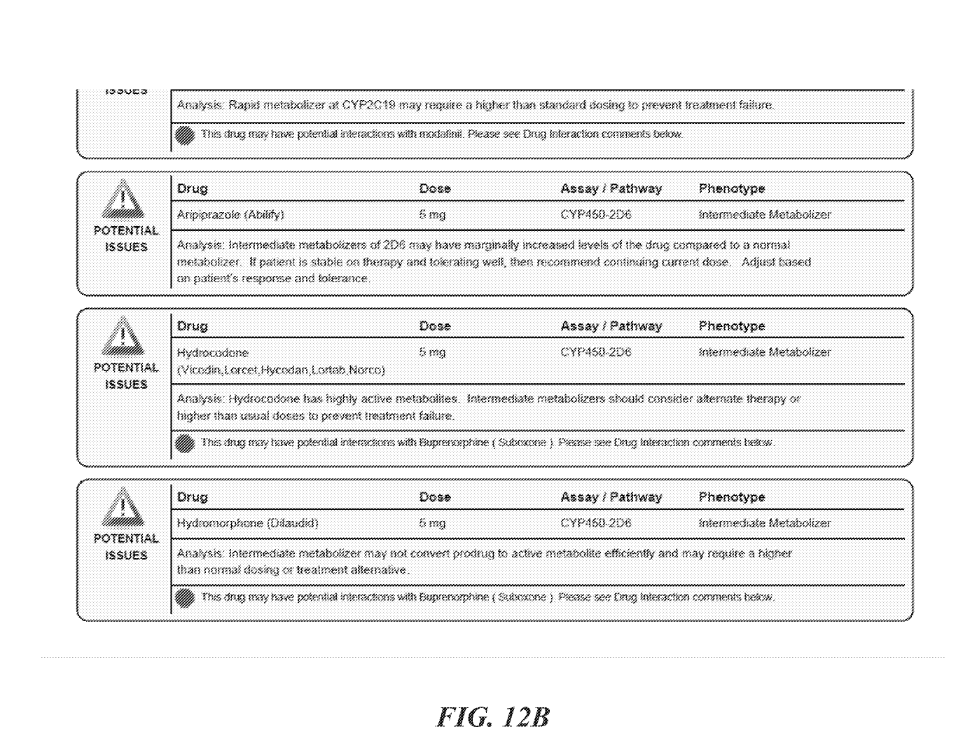

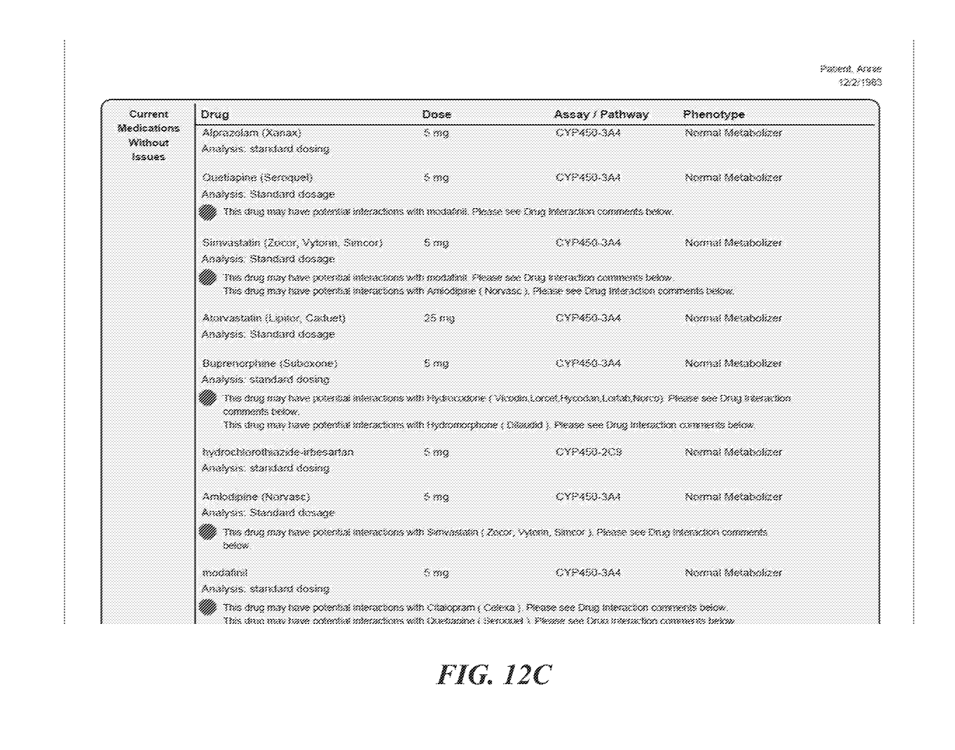

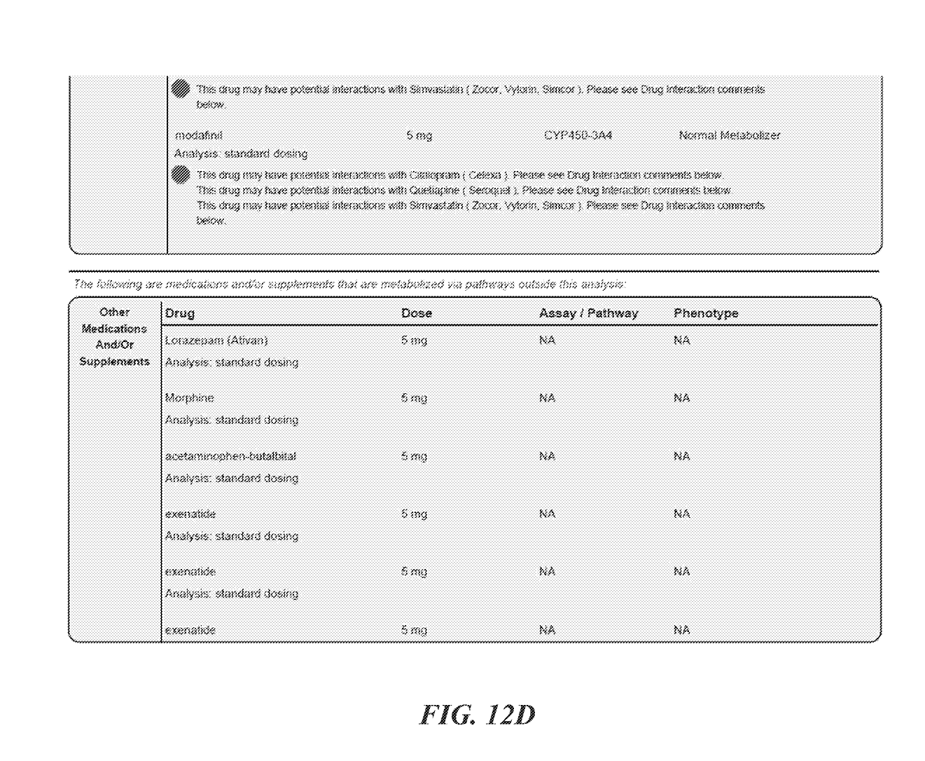

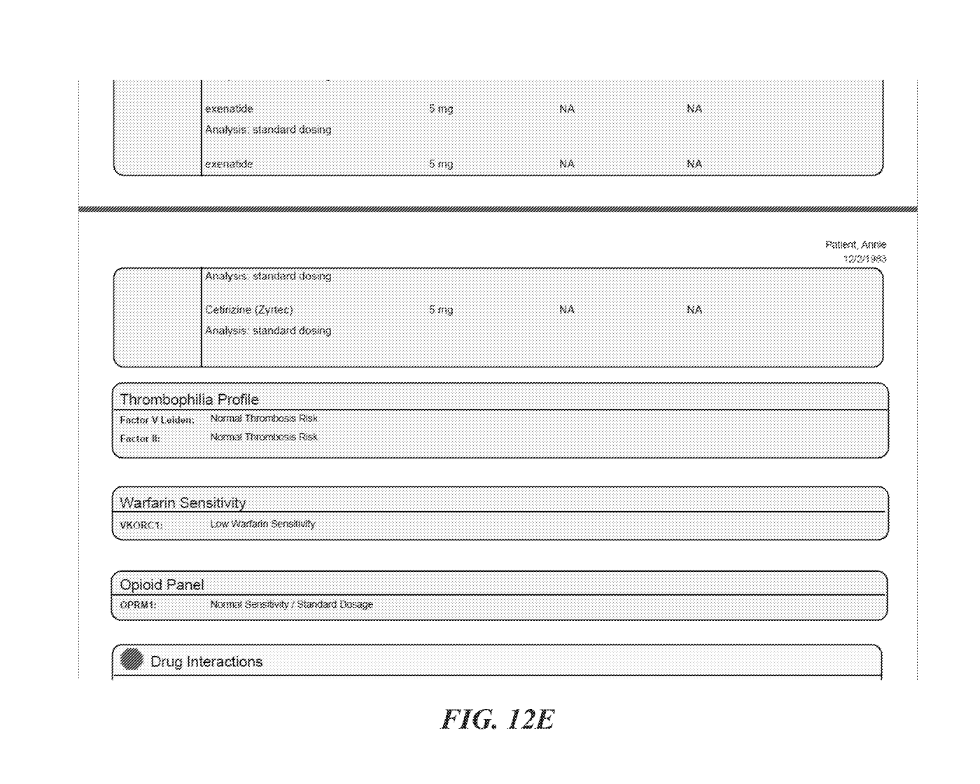

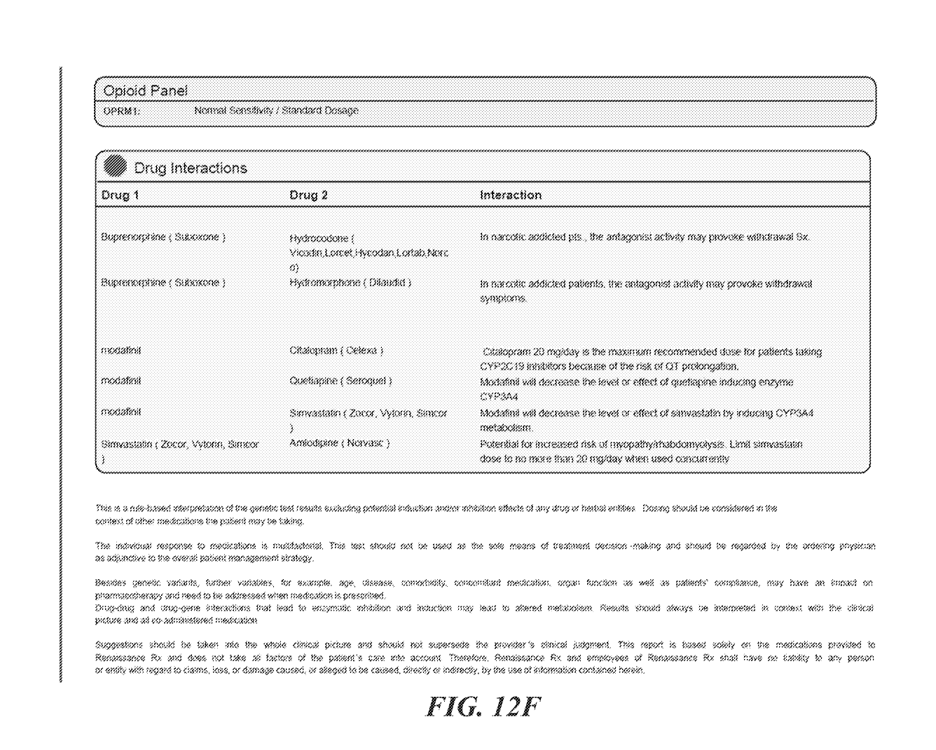

FIGS. 12A-12F respectively illustrate portion of an example analysis report that includes detailed analysis of the medication-to-medication interactions for each medication.

In some embodiments, the analysis report in the embodiments of FIGS. 11A-11C and 12A-12F is in an electronic format that can be displayed, for example, on a user interface associated with a client device of a user (e.g., patient, patient's physician, patient's family member, patient's friend, or any other authorized users). In some embodiments, the analysis report is in a Portable Document Format (e.g., a PDF document).

FIG. 13 illustrates a process 1300 for generating a detailed analysis of medication interaction for a patient. In some embodiments, the process 1300 can be executed by the server 130 of FIG. 1. In such embodiments, the server 130 can communicate with the medication analysis application 132 to deliver the detailed analysis to the patient at the client device 110.

The process 1300 starts at block 1302 where the server 130 obtains a variety of information associated with the patient's health. In one embodiment, the server 130 obtains, from a remote healthcare system, laboratory test results (“lab results”) associated with a patient. The lab results can be obtained, or collected, when a patient visits a DNA test laboratory (e.g., a laboratory that utilizes the remote healthcare system to store patient data) to obtain information about the patient's DNA make-up (i.e., DNA profile). In one example, such “DNA test” tests a patient's DNA to provide information on how the patient is affected by the different pathways. When a patient initially goes in to get the DNA test, the patient will provide a list of medications she is taking. As will be discussed below, that is list of medications is the initial list that that patient will obtain analysis details (e.g., as provided by the medication analysis engine 220).

In a conventional process, the patient typically has to make a special request to obtain the data, and even so, the data comes in a raw, complex format that only the most trained specialist (e.g., DNA researchers, pharmacists, laboratory professionals, etc.) would be able to comprehend. In contrast, the disclosed technology enables the patient to access the DNA test results at any time through any device belonging, or accessible, to the patient, such as her mobile phone, where the DNA test results are translated into a comprehensible format (e.g., plain English terminology). Accordingly, the patient, and any party of interest without a specialized DNA background, are able to understand better critical information about the patient to administer healthcare.

In accordance with the embodiment of FIG. 2, the server 130 communicates with a computer system associated with the DNA laboratory (e.g., healthcare server 140) to collect the patient's lab results, or DNA test results. The server 130 can obtain the lab results by having the patient, for example, submit a registration key (e.g., FIG. 3B). The registration key can be a key that allows the server 130 to communicate with the healthcare server that is employed by the DNA laboratory (e.g., healthcare server 140), and identifies to the healthcare server which patient's DNA test results the server 130 wants to obtain data. Alternatively, the server 130 can obtain the data by requesting the patient herself to submit information, which can then be relayed to the healthcare server to identify the patient and obtain the DNA test results (e.g., FIG. 3C). For example, the patient, in addition to the physician's visit, also visits another lab to provide DNA samples in order to obtain results of the make-up of her genetics. The DNA test results are stored computer system of that physician, e.g., in a DNA patient database, where that computer system (e.g., server 140) is also in communication with the server 130. The server 130 accesses the patient's DNA test results in order to analyze the patient's reaction to one or more medications she is currently taking, as will be discussed further below.

In some embodiments, the server 130 can obtain medical profile of the patient , e.g., from a second remote healthcare server and/or the same server from which it has obtained the DNA test results. The medical profile can include DNA profile, medical history, a list of medications being taken, or that have been taken, by the patient. The medical profile can be obtained, or collected, from the physician's office, or from a plurality of other sources associated with the patient with which the server 130 communicates (e.g., hospitals, other physician offices, pharmacies, and/or the like).

At block 1304, the server 130 obtains medication-interaction information for a plurality of medications. In some embodiments, the medication-interaction information includes one or more medication-interaction mappings for one or more medications. Each mapping maps an effect of a particular medication to a particular genotype/phenotype combination; that is, a particular medication-interaction mapping stores the effect a particular medication has on a particular genotype-phenotype combination. In some embodiments, the medication-interaction information includes predetermined medication-to-medication interactions between pairs of medications (i.e., “drugs”).

In some embodiments, the medication interaction information can be obtained from a medication-interaction database that stores predetermined medication-interaction information. By looking at the predetermined medication-interaction information, the server 130 is provided with the knowledge of how a medication is affected by the different pathways and for particular DNA profiles (e.g., genotype/phenotype combinations). The server 130 can look up the information in the database and compare that information to the patient's DNA profile and/or DNA test results in order to determine, almost instantaneously, how a new medication might affect the patient.

In some embodiments, the medication interaction information is generated by the server 130. In such embodiments, the server 130, over time, analyzes data from a wide range of patients that are under medication (e.g., patients with different genotype/phenotype combinations taking a variety of medications). The medication-interaction information can include medication pathway mappings and/or medication-to-medication interactions. As used here, a “medication pathway” is a pathway through which a medication gets processed by a particular type of person. Knowledge of a medication's multiple pathways can enable further analysis of how the pathways affect different genotype. For example, knowing a particular medication is processed through a particular pathway based on a particular genotype can help determine, or predict, that the medication will likely affect similarly a particular patient who shares the same genotype. An example user interface presenting an example pathway and its effect as mapped to a genotype is shown in FIG. 6A.

According to some embodiments, to generate the medication pathway mappings, the server 130 analyzes, or examines, the primary and secondary pathways of each medication in correlation to the patient's genotype and phenotype combination. This can be done, for example, when the server 130 receives the DNA test results at step 1302. The server 130 uploads this information to the patient's application profile to be displayed, for example, on the medication analysis application 132 installed on the patient's client device 110. The server 130 further can store the analysis of the medication as a medication pathway mapping, so that medication pathway mapping can be auto-loaded for all future patients with the same genotype and phenotype combination (e.g., for the detailed analysis of the patient in block 208). For example, if analysis of the DNA test results of a patient indicates that the patient is on Plavix® and is a poor metabolizer of that medication, the system stores that analysis for examination of a next patient. In such example, the system can auto-load the same notes (e.g., poor metabolizer of Plavix® of X and Y genotype-phenotype combination) for the medical profile and/or analysis report for that next patient.

Additionally, in some embodiments, the server 130 analyzes a medication's interaction with another medication (e.g., different pairs medications of the list of medications being taken by the patient), and the effect associated with that interaction. The medication-to-medication interaction is also stored in a database of the server 130 for future uses (e.g., to create additional detailed analysis for the patient).

At block 1306, the server 130 generates a detailed analysis associated with the patient based on the information obtained from blocks 1302 and 1304. According to some embodiments, the medication analysis platform system generates the detailed analysis based on a comparison of the patient's medical profile with multiple other patient profiles that have been analyzed for the medication-interaction information. In particular, the server 130 determines the current list of medications taken by the patient and the genotype/phenotype combination of the patient based on the patient's medical profile. The server 130 identifies a match between the medical profile of the given patient and a given medication pathway mapping of the multiple medication pathway mappings. This can be done for each medication of the list of medications currently taken by the patient. The server 130 generates the detailed analysis of the medication's effect on the patient by using the medication pathway mappings generated and/or obtained in block 1304.

At block 1308, the server 130 determines whether the patient has submitted a new medication to add to the current list of medications. If there is a new medication, the server 130 proceeds back to block 1306 to update the medical profile and to update the detailed analysis generated for the patient. If there is no new medication, the process 1300 returns.

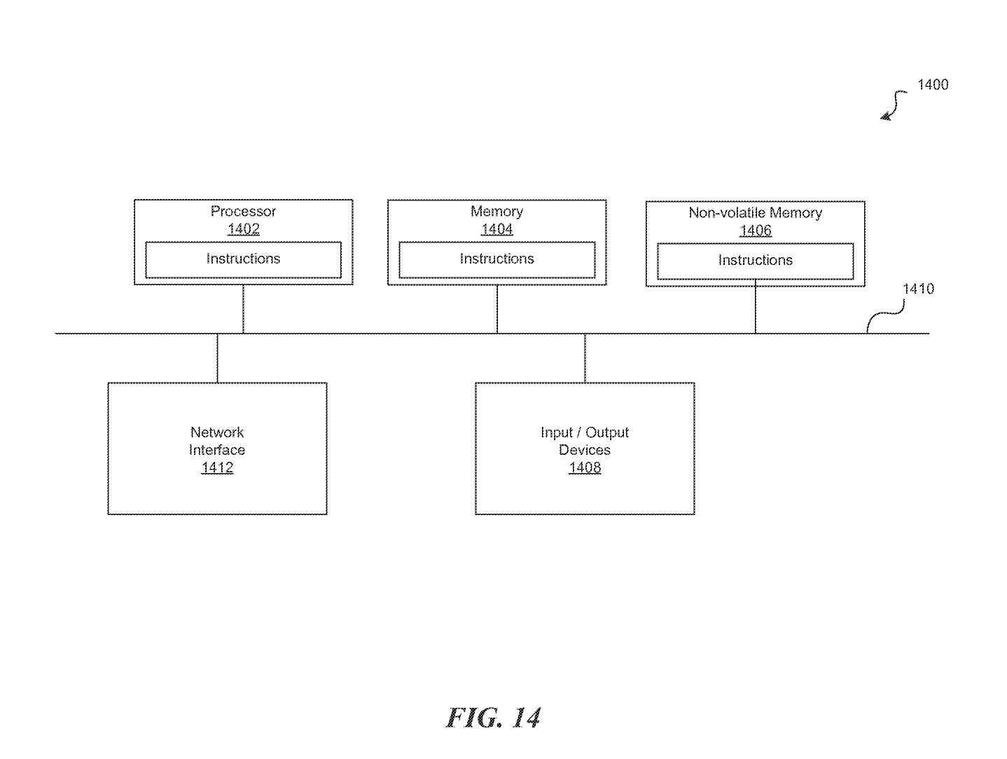

FIG. 14 shows a diagrammatic representation of a machine 1400 in the example form of a computer system within which a set of instructions, for causing the machine to perform any one or more of the methodologies discussed herein, can be executed. In alternative embodiments, the machine 1400 operates as a standalone device or can be connected (e.g., networked) to other machines. In a networked deployment, the machine can operate in the capacity of a server or a client machine in a client-server network environment, or as a peer machine in a peer-to-peer (or distributed) network environment.

The machine 1400 can be a server computer, a client computer, a personal computer (PC), a mobile electronic user device, a tablet PC, a laptop computer, a set-top box (STB), a personal digital assistant (PDA), a cellular telephone or a smart phone (e.g., an iPhone or an Android phone), a web-enabled household appliance, a network router, switch or bridge, a (hand-held) gaming device, a music player, or any machine capable of executing a set of instructions (sequential or otherwise) that specify actions to be taken by that machine.

The computing system 1400 may include one or more central processing units (“processors”) 1402, main memory 1404, non-volatile memory 1406 (e.g., flash memory, hard disks, floppy disks, etc.), one or more input/output devices 1408 (e.g., keyboard input devices, pointing devices, video display devices, etc.), and one or more network interface devices 1412 for communication over a network 1414, all of which are connected to an interconnect 1410. The interconnect 1410 is illustrated as an abstraction that represents any one or more separate physical buses, point to point connections, or both connected by appropriate bridges, adapters, or controllers. The interconnect 1410, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

The memory 1404 and non-volatile memory 1406 are computer-readable storage media that may store instructions that implement at least portions of the described technology. The instructions stored in memory 1404 can be implemented as software and/or firmware to program the processor(s) 1402 to carry out actions described above. In some embodiments, such software or firmware may be initially provided to the processing system 1400 by downloading it from a remote system through the computing system 1400 (e.g., via network interface 1412).

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device 1412 enables the machine to mediate data in a network with an entity that is external to the host server, through any known and/or convenient communications protocol supported by the host and the external entity. The network interface device 1412 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device 1412 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall can additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed in parallel, or can be performed at different times. Further, any specific numbers noted herein are only examples: alternative implementations can employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that can be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system can vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, 116, other aspects can likewise be embodied as a means-plus-function claim, or in other forms, such as being embodied in a computer-readable medium. (Any claim intended to be treated under 35 U.S.C. §112, 116 begins with the words “means for”.) Accordingly, the applicant reserves the right to add additional claims after filing the application to pursue such additional claim forms for other aspects of the disclosure.

What is claimed is:

1. A method comprising:
obtaining, at a medication analysis platform system, a first dataset from a first remote healthcare system, the first dataset including a list of medications associated with a given patient and DNA test results associated with the given patient, the first remote healthcare system associated with a first healthcare provider administering healthcare to the given patient;
identifying, by the medication analysis platform system, a DNA profile associated with the given patient based on the DNA test results;
obtaining, by the medication analysis platform system, medication-interaction information from a medication-interaction database, wherein the medication-interaction information includes multiple medication pathway mappings based on genotype-phenotype combinations; and
generating, by the medication analysis platform system, an analysis report for the list of medications associated with the given patient by identifying a match between the DNA profile of the given patient and a given medication pathway mapping of the multiple medication pathway mappings.

2. The method of claim 1, wherein each mapping of the multiple medication pathway mappings stores an effect of a particular medication in correspondence with a particular genotype-phenotype combination.

3. The method of claim 1, wherein the medication-interaction information from the medication-interaction database is recorded based on DNA test results associated with multiple patients under medication.

4. The method of claim 1, the medication-interaction information further includes multiple medication-to-medication interactions, wherein each medication-to-medication interaction of the multiple medication-to-medication interactions includes an effect between a pair of medications interacting.

5. The method of claim 4, wherein the analysis report includes at least some of the multiple medication-to-medication interactions that correspond to the list of medications associated with the given patient.

6. The method of claim 1, wherein the analysis report includes an effect of each medication of the list of medications associated with the given patient based on the multiple medication pathway mappings.

7. The method of claim 1, wherein the analysis report is generated in a form comprising any of:
a user interface associated with a client device of the given patient; or a Portable Document Format (PDF) document.

8. The method of claim 1, wherein the client device of the given patient includes any of a smartphone, a tablet, a laptop, or a desktop.

9. The method of claim 1, wherein the list of medication is updated with new medications input by the given patient through a client device of the given patient.

10. The method of claim 9, wherein the method further comprises:
responsive to said input of the new medications, updating the analysis report for the list of medications associated with the given patient.

11. The method of claim 1, wherein the DNA profile identifies a genotype-phenotype combination associated with the given patient, wherein generating the analysis report further comprises:
analyzing, by the medication analysis platform system, the first dataset to determine an effect of the list of medications on the given patient;
generating a particular set of medication pathway mappings based on the analyzed effect of the list of medications on the given patient, the generating including correlating the DNA profile with the list of medications, wherein each mapping of the particular set of medication pathway mappings stores the analyzed effect of each medication of the list of medications in correspondence with the genotype-phenotype combination associated with the given patient; and
updating the medication-interaction information in the medication-interaction database with the particular set of medication pathway mappings.

12. The method of claim 1, further comprising:
obtaining, at the medication analysis platform system, a second dataset including a new list of medications associated with the given patient, the new list of medications including one or more medications to be taken by the given patient;
generating a particular set of medication pathway mappings by correlating the DNA test results with the particular list of medications, wherein each mapping of the particular set of medication pathway mappings stores an effect of each medication of the particular list of medications in correspondence with the particular genotype-phenotype combination associated with the given patient; and
updating the medication-interaction information in the medication-interaction database with the particular set of medication pathway mappings.

13. The method of claim 12, wherein the new list of medications is obtained from the given patient via a user interface of a mobile application associated with the medication analysis platform system.

14. A system comprising:
a processor;
a medication analysis engine coupled to the processor to:
obtain a first dataset from a first remote healthcare system, the first dataset including a list of medications associated with a given patient and DNA test results associated with the given patient, the first remote healthcare system associated with a first healthcare provider administering healthcare to the given patient;
identify a DNA profile associated with the given patient based on the DNA test results;
obtain medication-interaction information from a medication-interaction database, wherein the medication-interaction information includes multiple medication pathway mappings based on genotype-phenotype combinations; and
generate an analysis report for the list of medications associated with the given patient by identifying a match between the DNA profile of the given patient and a given medication pathway mapping of the multiple medication pathway mappings.

15. The system of claim 14, wherein the medication analysis engine is further configured to:
obtain a second dataset including a new list of medications associated with the given patient, the new list of medications including one or more medications to be taken by the given patient;
generate a particular set of medication pathway mappings by correlating the DNA test results with the particular list of medications, wherein each mapping of the particular set of medication pathway mappings stores an effect of each medication of the particular list of medications in correspondence with the particular genotype-phenotype combination associated with the given patient; and
update the medication-interaction information in the medication-interaction database with the particular set of medication pathway mappings.

16. The system of claim 14, wherein the analysis report includes an effect of each medication of the list of medications associated with the given patient based on the multiple medication pathway mappings.

17. The system of claim 14, wherein the DNA profile identifies a genotype-phenotype combination associated with the given patient, and wherein to generate the analysis report further comprises:
analyze the first dataset to determine an effect of the list of medications on the given patient;
generate a particular set of medication pathway mappings based on the analyzed effect of the list of medications on the given patient, the generating including correlating the DNA profile with the list of medications, wherein each mapping of the particular set of medication pathway mappings stores the analyzed effect of each medication of the list of medications in correspondence with the genotype-phenotype combination associated with the given patient; and
update the medication-interaction information in the medication-interaction database with the particular set of medication pathway mappings.

18. The system of claim 14, wherein the analysis report is generated in a form comprising any of:
a user interface associated with a client device of the given patient; or
a Portable Document Format (PDF) document.

19. The system of claim 14, wherein the analysis report includes at least some of the multiple medication-to-medication interactions that correspond to the list of medications associated with the given patient.

20. The system of claim 14, wherein the analysis report includes an effect of each medication of the list of medications associated with the given patient based on the multiple medication pathway mappings.
